(19) United States
(12) Patent Application Publication
(10) Pub. No.: US 2018/0270216 A1
(43) Pub. Date: Sep. 20, 2018

(54) ELECTRONIC DEVICE SYSTEM, COMMUNICATION METHOD AND RECORDING MEDIUM

(71) Applicant: Ryuichiro NAKAYAMA, Kanagawa (JP)

(72) Inventor: Ryuichiro NAKAYAMA, Kanagawa (JP)

(73) Assignee: Ricoh Company, Ltd., Tokyo (JP)

(21) Appl. No.: 15/904,630

(22) Filed: Feb. 26, 2018

(30) Foreign Application Priority Data
Mar. 17, 2017 (JP) 2017-053449

(51) Int. Cl. H04L 29/06; G06F 21/31; G06F 9/445

(52) U.S. Cl. CPC H04L 63/083; H04L 63/102; G06F 9/4451; G06F 21/31

(57) ABSTRACT

An electronic device system includes a terminal device and an electronic device. The terminal device includes a memory and a sender. The memory stores user setting information about a setting of an electronic device, and the sender transmits a login request and the user setting information to the electronic device. The electronic device includes a receiver, an authentication processor, and an electronic device controller. The receiver receives the login request and the user setting information from the terminal device. The authentication processor performs a process relating to user authentication by using authentication information included in the login request. The electronic device controller controls the electronic device according to the user setting information if the user authentication performed by the authentication processor succeeds.

### CROSS-REFERENCE TO RELAYED APPLICATION

This patent application is based on and claims priority pursuant to 35 U.S.C. § 119 to Japanese Patent Application No. 2017-053449, filed on Mar. 17, 2017, in the Japan Patent Office, the entire disclosure of which is hereby incorporated by reference herein.

### BACKGROUND

### Technical Field

Exemplary aspects of the present disclosure relate to an electronic device system a communication method and a recording medium.

### Related Art

An electronic device placed in an office may be shared by multiple users in the office. Meanwhile, the electronic device identifies a user. The identification of the user enables a suitable process to be performed for the user. For example, restrictions on the use of the electronic device can be imposed, and a folder to be allocated to each user can be specified. User authentication can be performed by an authentication server or a general directory service such as an active directory (AD) and an open lightweight directory access protocol (OpenLDAP).

In the AD or the OpenLDAP, information such as a user name (e.g., a mail address) and a password is stored as authentication information. In addition to the user name or the mail address, the authentication server manages user setting information (e.g., use authority, a rule to be applied when a use limit is reached, a delivery destination folder for each user, billing system information, and integrated circuit (IC) card information) that is difficult to be managed by the AD or the OpenLDAP. Moreover, the user authentication capability of the AD or the OpenLDAP may be used. In such a case, the authentication server can manage only user setting information without managing the authentication information, and use an authentication result acquired by the AD or the OpenLDAP.

### SUMMARY

In at least one embodiment of this disclosure, there is provided an improved electronic device system that includes an electronic device and a terminal device. The terminal device includes a memory and a sender. The memory stores user setting information about a setting of the electronic device, and the sender transmits a login request and the user setting information to the electronic device. The electronic device includes a receiver, an authentication processor, and an electronic device controller. The receiver receives the login request and the user setting information from the terminal device. The authentication processor performs a process relating to user authentication by using authentication information included in the login request. The electronic device controller controls the electronic device according to the user setting information if the user authentication performed by the authentication processor succeeds.

Further provided is an improved communication method performed by an electronic device system including an electronic device and a terminal device that communicate with each other. The communication method includes storing, transmitting, receiving, performing, and controlling. The storing user setting information about a setting of the electronic device in the terminal device. The transmitting the user setting information and a login request from the terminal device to the electronic device. The receiving, by the electronic device, the login request and the user setting information from the terminal device. The performing a process relating to user authentication by the electronic device using authentication information included in the login request. The controlling the electronic device according to the user setting information if the user authentication succeeds.

Further provided is an improved non-transitory computer-readable recording medium storing program code that, when executed by an electronic device system including an electronic device and a terminal device that communicate with each other, causes the electronic device system to perform the communication method described above.

### BRIEF DESCRIPTION OF THE DRAWINGS

The aforementioned and other aspects, features, and advantages of the present disclosure would be better understood by reference to the following detailed description when considered in connection with the accompanying drawings, wherein:

FIG. 1 is a diagram schematically illustrating an electronic device system according to an exemplary embodiment;

FIG. 2 is a diagram illustrating one example of a configuration of the electronic device system;

FIG. 3 is a diagram illustrating one example of a software configuration of an electronic device and a terminal device;

FIG. 4 is a hardware configuration diagram illustrating one example of the terminal device;

FIG. 5 is a hardware configuration diagram illustrating one example of the electronic device;

FIGS. 6A and 6B (collectively referred to as FIG. 6) are functional block diagrams illustrating one example of functions of the terminal device and the electronic device of the electronic device system;

FIG. 7 is a sequence diagram illustrating one example of a procedure performed when an administrator sets authentication information and user setting information;

FIG. 8 is a sequence diagram illustrating one example of a procedure performed when a user sets a terminal authentication application in the terminal device;

FIGS. 9A, 9B, and 9C (collectively referred to as FIG. 9) are sequence diagrams illustrating one example of a procedure performed when the user copies user setting information in the electronic device to the terminal device;

FIG. 10 is a diagram illustrating one example of a change in the user setting information stored in the terminal device;

FIGS. 11A, 11B, and 11C (collectively referred to as FIG. 11) are sequence diagrams illustrating one example of a procedure performed when the user logs in the electronic device to transmit the user setting information in the terminal device to the electronic device;

FIG. 12 is a sequence diagram illustrating one example of a procedure performed when a job using the user setting information is executed;

FIGS. 13AA and 13AB (collectively referred to as FIG. 13A) are sequence diagrams illustrating one example of a procedure performed when the user logs in the electronic device to transmit the user setting information in the terminal device to the electronic device;

FIGS. 13BA, 13BB, and 13BC (collectively referred to as FIG. 13B) are sequence diagrams illustrating one example of a procedure performed when the user logs in the electronic device to transmit the user setting information in the terminal device to the electronic device; and

FIG. 14 is a sequence diagram illustrating one example of an authentication process using an IC card.

The accompanying drawings are intended to depict exemplary embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that have the same function, operate in a similar manner and achieve similar results.

Although the exemplary embodiments are described with technical limitations with reference to the attached drawings, such description is not intended to limit the scope of the disclosure and all of the components or elements described in the exemplary embodiments of this disclosure are not necessarily indispensable.

Referring now to the drawings, exemplary embodiments of the present disclosure are described below. In the drawings for explaining the following exemplary embodiments, the same reference codes are allocated to elements (members or components) having the same function or shape and redundant descriptions thereof are omitted below.

### <Brief Description of Electronic Device System>

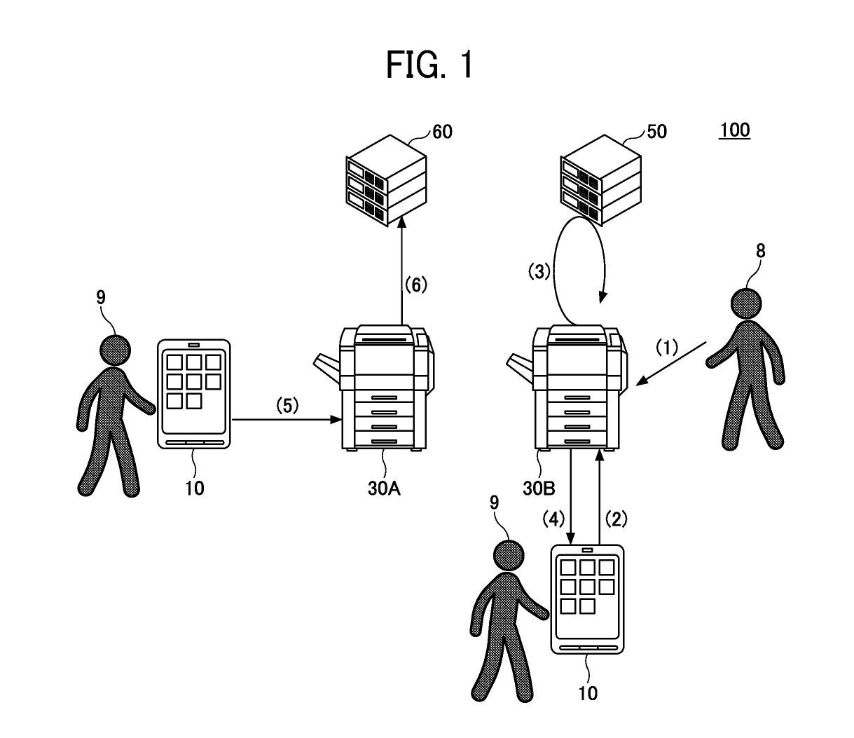

FIG. 1 is a diagram schematically illustrating an electronic device system 100 according to an exemplary embodiment. In FIG. 1, a multifunctional peripheral (MFP) is described as one example of an electronic device 30. The electronic device system 100 of the present exemplary embodiment has a server-less configuration that does not need an authentication server. In the server-less configuration, a terminal device 10 carried by a user 9 manages user setting information that was conventionally managed in a local database (DB) of the electronic device 30.

An administrator 8 of a plurality of electronic devices 30 (e.g., electronic devices 30A and 30B in FIG. 1) sets user setting information in one of the electronic devices 30, as indicated by an arrow (1) illustrated in FIG. 1. Such an electronic device 30 is called a representative device. In the present exemplary embodiment, an electronic device 30B serves as the representative device. When the user 9 brings the terminal device 10 close to the electronic device 30B in which the user setting information has been set to request the user setting information, the terminal device 10 transmits authentication information to the electronic device 30B, as indicated by an arrow (2) illustrated in FIG. 1. The electronic device 30B communicates with a directory server 50 as necessary to authenticate the user 9, as indicated by an arrow (3) illustrated in FIG. 1. The authentication can be performed by the electronic device 30B. If the authentication succeeds, the electronic device 30B transmits the user setting information to the terminal device 10, as indicated by an arrow (4) illustrated in FIG. 1. Accordingly, in the present exemplary embodiment, the terminal device 10 carried by each user 9 can retain user setting information. The user 9 may use an optional electronic device 30A. In such a case, since the electronic device 30A acquires user setting information from the terminal device 10, the electronic device 30A can perform control based on various information such as use authority, a rule to be applied when a use limit is reached, a delivery destination folder for each user, information about a billing system 60, and IC card information, an indicated by an arrow (5) illustrated in FIG. 1. When the electronic device 30A is used by the user 9, the electronic device 30A transmits information necessary for billing to the billing system 60, as indicated by an arrow (6) illustrated in FIG.

Accordingly, the terminal device 10 carried by the user 9 retains user setting information, so that the administrator 8 does not need to register user setting information of all the users who use the electronic device 30 in the local DB of each electronic device 30, thereby saving labor of the administrator 8.

### <Terminology>

User setting information represents information that is set in the electronic device 30, and can differ for each user. The electronic device 30 performs a given process based on the user setting information. The user setting information does not need to be completely different for each user. Some users can have the same user setting information. Moreover, one portion of the user setting information may include information that is not preferably edited by a user.

If user authentication by an authentication processor succeeds, an electronic device controller controls the electronic device according to the user setting information. The control of the electronic device represents an operation or a process that is performed to provide a function of the electronic device. Alternatively, the control of the electronic device can represent a process that occurs in association with the use of the electronic device. Examples of such a process include use restriction based on the use authority, and a billing process.

### <Example of System Configuration>

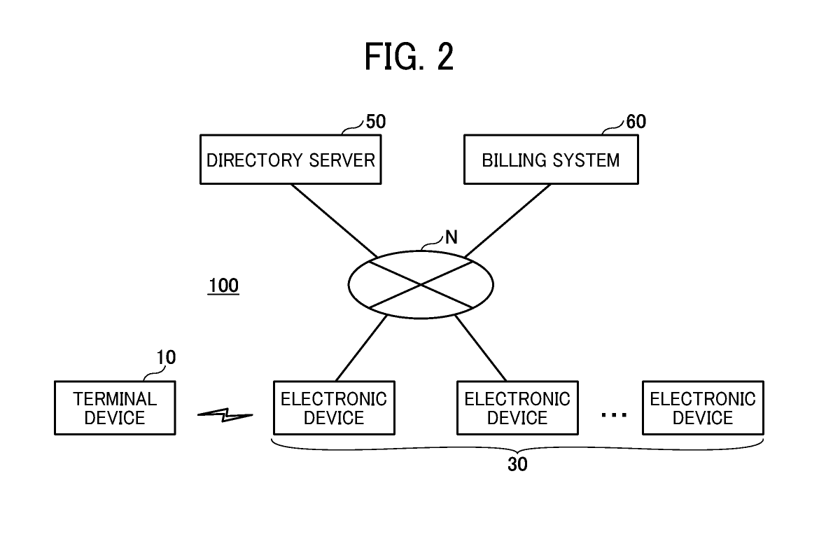

FIG. 2 is a diagram illustrating an example of a configuration of the electronic device system 100 of the present exemplary embodiment. The electronic device system 100 includes the electronic device 30 and the terminal device 10 that are wirelessly communicable.

The electronic device 30 is capable of authenticating (or need to authenticate) the user 9. Moreover, the electronic device 30 preferably has a communication function of communicating with the terminal device 10. An MFP is one example of the electronic device 30. The MFP as the electronic device 30 has at least two of a print function, a scanner function, a copy function, and a facsimile function. Such an electronic device 30 can also be called the MFP, a printer, an image forming apparatus, or an information processing apparatus.

Moreover, the electronic device 30 can be, for example, a projector or an electronic blackboard. The electronic device 30 as the projector projects an image input from an external unit onto a screen. Such an electronic device 30 can be called a projection apparatus. The electronic device 30 as the electronic blackboard displays a stroke by connecting positions of a pen or a fingertip detected by a touch panel. Such electronic device 30 can be called an electronic information board or an electronic whiteboard.

When the user 9 logs in the electronic device 30, the user 9 performs an operation on the terminal device 10. Thus, the electronic device 30 may not need an operation panel (an input device and a display device). Moreover, since the electronic device 30 communicates with the directory server 50, the electronic device 30 has a function of connecting the electronic device 30 to a network. However, since the communication with the directory server 50 is not required, the function of connecting the electronic device 30 to the network is not required.

A network N includes a local area network (LAN) laid in a facility where the electronic device 30 is present, a line provided by a line provider, and a provider network connected to the Internet by using the line. The Internet connects computers in the world, and is a network by which networks in the world are mutually connected.

The network N can be either a wired network or a wireless network. Moreover, the network N can be a combination of a wired network and a wireless network. If the electronic device 30 has a line-switching communication function conforming to the standard such as third generation (3G), fourth generation (4G), long-term evolution (LTE), and worldwide interoperability for microwave access (WiMAX), the LAN is not necessary. In such a case, the electronic device 30 can be connected to the Internet via a line provided by a 3G, 4G, LTE, or WiMAX line provider. The network N can include only a LAN.

The terminal device 10 is carried by the user 9. The terminal device 10 can be called a smart device or a mobile device. The terminal device 10 is, for example, a smart phone, a tablet terminal, a personal computer (PC), a personal digital assistant (PDA), a sunglasses-type or wristband-type wearable computer, and a portable game machine.

The terminal device 10 has a function of communicating with the electronic device 30 in a wired manner or a wireless manner. Although examples of communication methods include Bluetooth (registered trademark), Bluetooth Low Energy (registered trademark, hereinafter omitted), a wireless LAN, near field communication (NFC), and ZigBee (registered trademark), the communication methods are not limited thereto. If the user 9 logs in the electronic device 30 by using the communication function, the electronic device 30 refers to the user setting information retained by the terminal device 10.

The electronic device system 100 includes the directory server 50, and the electronic device 30 can communicate with the directory server 50 although such a configuration may not be required. The user authentication can be performed using a local DB of the electronic device 30 only if the electronic device 30 cannot communicate with the directory server 50.

The directory server 50 is an information processing apparatus that provides an authentication system using a directory service. The term “directory service” used herein represents a service by which various resources on a network are associated and managed for retrieval. In particular, AD and OpenLDAP are known as directory services. When a director service is used, a communication protocol LDAP is used. However, such a communication protocol is but one example.

The directory server 50 stores information such as a mail address, user identification (ID), a password, a facsimile number, an affiliation, a class, and a name as user setting information. When the user 9 logs in the electronic device 30, the directory server 50 may perform user authentication according to a request from the electronic device 30.

If the directory server 50 determines that the user authentication has failed, the electronic device 30 determines that the user 9 is an external employee (a guest) and changes an authority to be used when the user 9 uses the electronic device 30. Moreover, if the authentication has succeeded, the electronic device 30 can apply a rule to be used when a use limit of a function of the electronic device 30 is reached according to an attribute (e.g., affiliation and class) of the user 9.

The billing system 60 is an information processing apparatus or an information processing system having a function of billing for the use of the electronic device 30. When the user 9 uses the electronic device 30, a point (e.g., a point to be converted into an amount of money) is calculated according to the number of output sheets, whether monochrome or color, and sheet size. Such a point is billed in association with the login user 9. In particular, the billing system 60 includes a MyPrint (registered trademark) system and a billing code.

### <Software Configuration>

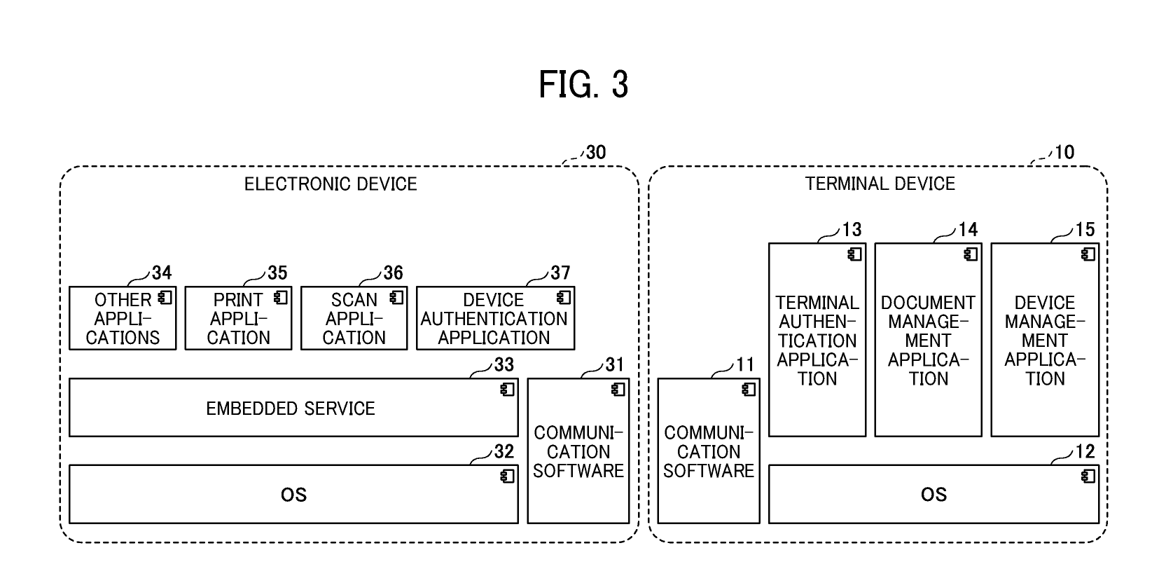

FIG. 3 is a diagram illustrating one example of a software configuration of the electronic device 30 and the terminal device 10. In the electronic device 30, an embedded service 33 operates on an operating system (OS) 32, whereas each of a print application 35, a scan application 36, a device authentication application 37, and other applications 34 operates on the embedded service 33. Moreover, the electronic device 30 includes communication software 31 that is linked to the OS 32 and the embedded service 33.

The OS 32 is designed for an embedded device. Examples of the OS 32 include Linux (registered trademark), Unix (registered trademark), Android (registered trademark), and Windows (registered trademark). An OS suitable for the embedded service 33 is used. The embedded service 33 interprets a process request from each application so that a hardware resource acquisition request is issued. Moreover, the embedded service 33 manages one or more hardware resources to adjust an acquisition request from each application. In particular, the embedded service 33 includes various services such as a network control service, an operation panel control service, a facsimile control service, a memory control services, and an engine control service.

Each of the print application 35, the scan application 36, and the other applications 34 performs a process relating to an operation to be performed by the user 9. The print application 35 generates a user interface for printing to accept setting input, whereas the scan application 36 generates a user interface for scanning to accept setting input. The other applications 34 include, for example, an application for log recording and an application for a menu screen on an operation panel. The device authentication application 37 communicates with a terminal authentication application 13 of the terminal device 10 to perform authentication and a user setting information related process. For example, the device authentication application 37 acquires and retains user setting information from another electronic device 30, and provides the user setting information to the terminal device 10.

The communication software 31 communicates with communication software 11 of the terminal device 10. The communication software 31 may be a short-range communication function such as Bluetooth Low Energy and near field communication (NEC), a personal area network (PAN) communication function such as Bluetooth and ZigBee, a LAN communication function such as wireless fidelity (Wi-Fi), and a communication function such as infrared-ray communication and a visible light communication.

In the terminal device 10, each of the terminal authentication application 13, a document management application 14, and a device management application 15 operates on an OS 12. The terminal device 10 includes communication software 11 that is linked to the OS 12 and the terminal authentication application 13. The OS 12 can differ depending on the terminal device 10. Examples of the OS 12 include Android (registered trademark), iOS (registered trademark), and Windows (registered trademark).

The terminal authentication application 13 performs a process that is needed for a user to log in the electronic device 30. For example, the terminal authentication application 13 displays a screen that accepts input of authentication information, and manages the authentication information input from the screen. Moreover, the terminal authentication application 13 manages user setting information acquired from the electronic device 30. The user setting information can be acquired by importing, downloading, or receiving. For example, the device authentication application 37 imports the user setting information from a file stored in a recording medium, downloads the user setting information via a network, or receives the user setting information from another electronic device 30 by using short-range wireless communication.

The document management application 14 and the device management application 15 are briefly described although the document management application 14 and the device management application 15 may not be necessary.

The document management application 14 manages document data to be used by the electronic device 30. Moreover, the document management application 14 receives image data scanned by the electronic device 30 from the electronic device 30 to manage such image data.

The device management application 15 manages settings and status of the electronic device 30. Moreover, the device management application 15 manages an event that has occurred in the electronic device 30. If the electronic device 30 is not connected to a network, the device management application 15 has a function of notifying a device management system (a system for remotely monitoring a state of the electronic device 30) of an event (an error state) of the electronic device 30, instead of the electronic device 30.

Moreover, the device management application 15 uses a function of the communication software 11 to make a setting such as a LAN setting, a domain name service (DNS) setting, and a proxy setting in the electronic device 30. With such a function, the user 9 simply holds the terminal device 10 over the electronic device 30, so that a setting that cannot be made via the LAN can be made.

Moreover, since the device management application 15 can notify the electronic device 30 of communication information for communication with the directory server 50 immediately before the user 9 logs in the electronic device 30, the administrator 8 may not need to set the communication information for communication with the directory server 50 for each electronic device 30 beforehand. The term “immediately before” used herein represents time at which the electronic device 30 requests authentication information from the terminal device 10.

### <Hardware Configuration>

### <<Terminal Device 10>>

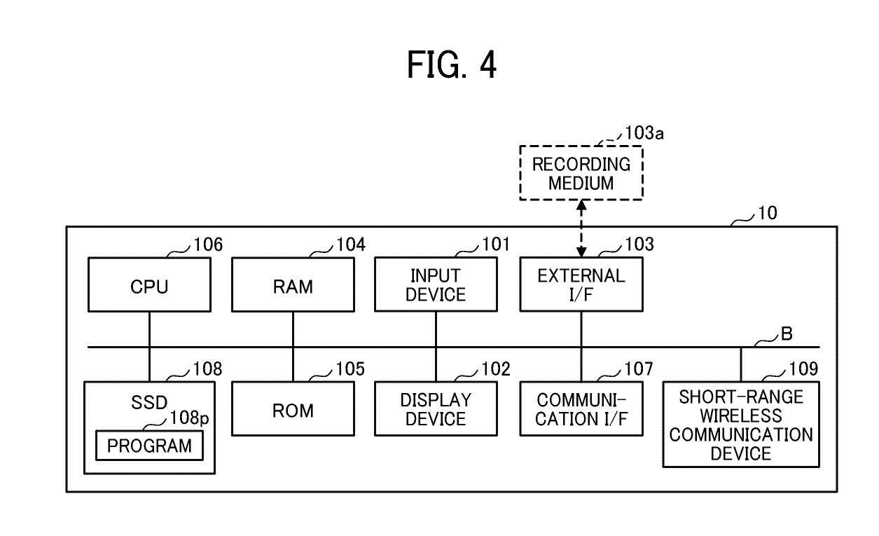

The terminal device 10 according to the present exemplary embodiment has a hardware configuration as illustrated in FIG. 4, for example. FIG. 4 is a hardware configuration diagram illustrating one example of the terminal device 10. The terminal device 10 illustrated in FIG. 4 includes an input device 101, a display device 102, an external interface (I/F) 103, a random access memory (RAM) 104, a read only memory (ROM) 105, a central processing unit (CPU) 106, a communication I/F 107, a solid state drive (SSD) 108, and a short-range wireless communication device 109 that are mutually connected via a bus B.

The input device 101 is, for example, a touch panel. The input device 101 is used to input each of operation signals to the terminal device 10. The input device 101 can be a keyboard and a mouse. The display device 102 is, for example, a liquid crystal display (LCD), and displays a result of a process performed by the terminal device 10.

The external I/F 103 interfaces with an external device such as a recording medium 103a. In the recording medium 103a, a program for providing a display method of the present exemplary embodiment can be stored. The terminal device 10 can read and/or write data from and/or to the recording medium 103a via the external 103.

The recording medium 103a is, for example, a secure digital (SD) memory card. The recording medium 103a can be a universal serial bus (USB) memory, a digital versatile disc (DVD), a compact disk (CD), and a flexible disk.

The RAM 104 is a volatile semiconductor memory (a storage device) that temporarily stores a program and data. The ROM 105 is a nonvolatile semiconductor memory (a storage device) that can retain a program and data even if the power is shut off. The ROM 105 stores data and a program such as a basic input/output system (BIOS), an OS setting, and a network setting to be executed when the terminal device 10 is activated.

The CPU 106 as an arithmetic device retrieves a program or data from a storage device such as the ROM 105 and the SSD 108 to the RAM 104 to execute a process, thereby comprehensively controlling the terminal device 10 or allowing the terminal device 10 to function.

The communication I/F 107 is used for communication via the network N. For example, the communication I/F 107 connects the terminal device 10 to the network N. Moreover, the communication I/F 107 can connect the terminal device 10 to a mobile telephone network and the Internet. In particular, the communication OF 107 serves as a wireless LAN communication device or a communication device via a mobile phone network.

The SSD 108 is a nonvolatile storage device in which a program 108p and data are stored. The program 108p and data to be stored in the SSD 108 include an OS as basic software for comprehensively controlling the terminal device 10, and an application for providing various functions on the OS. The SSD 108 manages the program and the data therein by using a predetermined file system and/or a database. The terminal device 10 can include a hard disk drive (HDD) instead of the SSD 108 or with the SSD 108.

The short-range wireless communication device 109 is a communication device conforming to the communication standard such as Bluetooth (registered trademark) and an NFC. If the short-range wireless communication device 109 conforms to the NFC, the short-range wireless communication device 109 can be called an IC card reader and/or writer. Thus, the terminal device 10 can perform data communication with the electronic device 30 via the short-range wireless communication device 109.

In the hardware configuration of the terminal device 10, the short-range wireless communication device 109 may become unnecessary and an HDD is included instead of the SSD 108. Even in such a case, the description of the present exemplary embodiment is not affected.

### <<Electronic Device>>

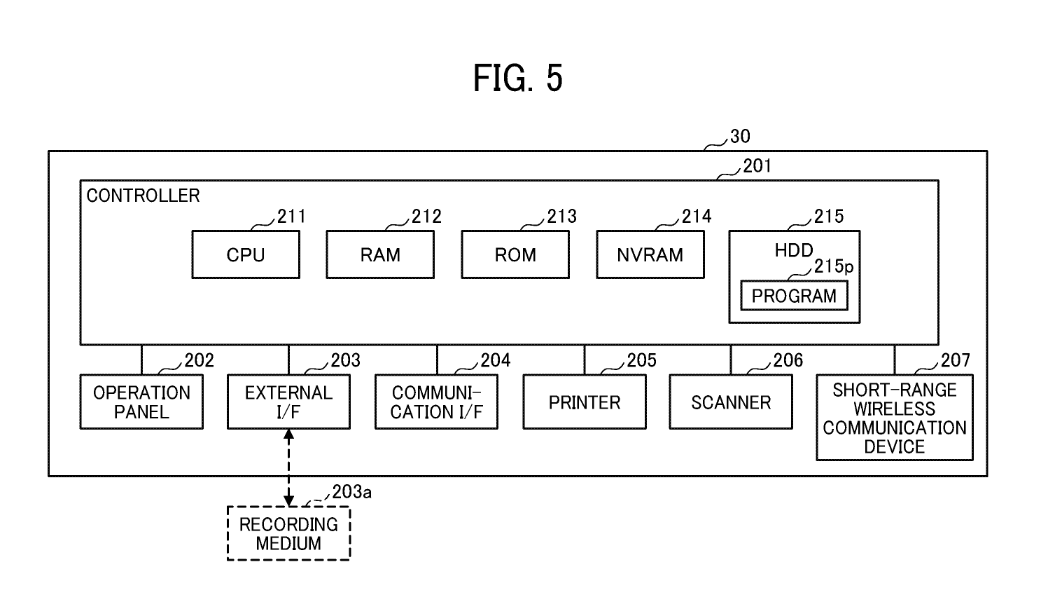

The electronic device 30 according to the present exemplary embodiment includes a hardware configuration as illustrated in FIG. 5. In FIG. 5, a multifunctional peripheral is illustrated as the electronic device 30. FIG. 5 is a hardware configuration diagram illustrating one example of the electronic device 30 according to the present exemplary embodiment. As illustrated in FIG. 5, the electronic device 30 includes a controller 201, an operation panel 202, an external I/F 203, a communication I/F 204, a printer 205, and a scanner 206.

The controller 201 includes a CPU 211, a RAM 212, a ROM 213, and a non-volatile random access memory (NVRAM) 214, and an HDD 215. The ROM 213 stores various programs and data. The RAM 212 temporarily stores a program and data. The NVRAM 214 stores setting information, for example. The HDD 215 stores various programs 215p and data.

The CPU 211 retrieves the program 215p, data, or setting information from the HDD 215, the NVRAM 214, or the ROM 213 to the RAM 212 to execute a process, thereby comprehensively controlling the electronic device 30 or allowing the electronic device 30 to function.

The operation panel 202 includes an input unit that receives an input from the user 9, and a display unit. In the present exemplary embodiment, an operation panel 202 of the electronic device 30 is not used. However, the operation panel 202 may receive a reading condition and a print setting.

The external I/F 203 interfaces with an external device. The external device includes a recording medium 203a. Examples of the recording medium 203a include a flexible disk, a CD, a DVD, a SD memory card, and a USB memory.

The communication I/F 204 is used for communication via the network N. In the present exemplary embodiment, the electronic device 30 may not be connected to the network N.

The printer 205 is a printing apparatus that prints a print target data. The scanner 206 is a reading apparatus that optically reads a document and converts the read document into electronic data. A short-range wireless communication device 207 is similar to the short-range wireless communication device 109 of the terminal device 10.

### <Functions>

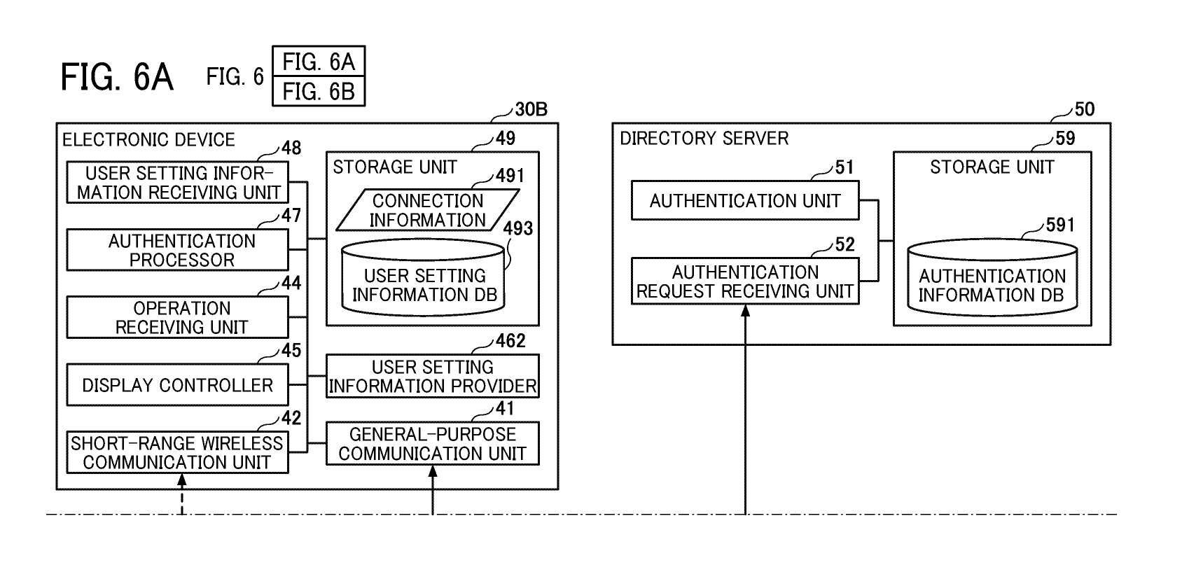

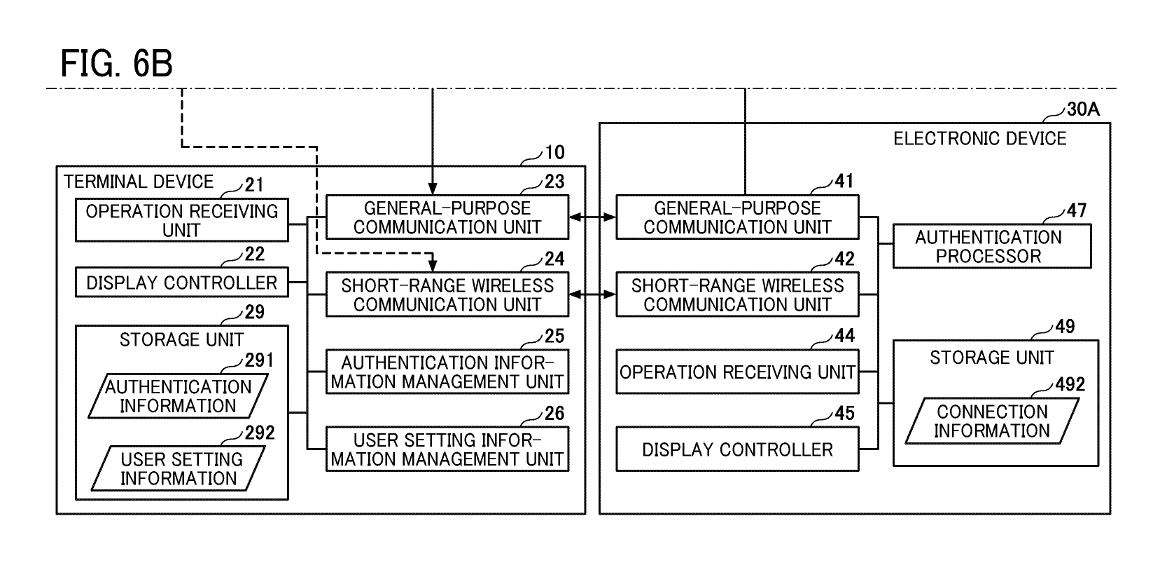

FIG. 6 is a functional block diagram illustrating one example of functions of the terminal device 10, the electronic device 30, and the directory server 50 in the electronic device system 100. FIG. 6 is divided into two diagrams of FIGS. 6A and 6B for the sake of convenience. The electronic device 30B is an electronic device 30 to which the administrator 8 sets user setting information. Moreover, when the terminal device 10 of the user 9 acquires user setting information, the electronic device 30B serves as an acquisition source. The electronic device 30B does not need to be a specific electronic device 30. The electronic device 30 to which the administrator 8 has set user setting information is the electronic device 30B.

### <<Terminal Device 10>>

The terminal device 10 includes an operation receiving unit 21, a display controller 22, a general-purpose communication unit 23, a short-range wireless communication unit 24, an authentication information management unit 25, and a user setting information management unit 26. Each of these functional units functions or performs an operation when the corresponding component illustrated in FIG. 4 operates based on a command from the CPU 106 according to the program 108p (the terminal authentication application 13) loaded to the RAM 104 from the SSD 108. However, some or all of the functions may be performed by a hardware circuit such as an IC, a large-scale integrated (LSI), an application specific integrated circuit (ASIC), and a field programmable gate array (FPGA).

Moreover, the terminal device 10 includes a storage unit 29 that is implemented by the RAM 104 or the SSD 108 and stores various information. In the storage unit 29, authentication information 291 and user setting information 292 are stored. TABLE 1 illustrates one example of authentication information, and TABLE 2 illustrates one example of user setting information.

TABLE 1

| User ID | Password |
|---|---|
| suzuki@sample.co.jp | ******** |

One example of authentication information is illustrated in TABLE 1. The authentication information 291 is information for the user 9 to log in the electronic device 30 or information for the user 9 to be authenticated by the electronic device 30. Thus, login and authentication may not be precisely distinguished from each other. For example, the authentication information 291 includes user ID and a password. The user ID is information to specify or identify the user 9. The ID represents an identifier or identification information. The ID is a name, a code, a character string, a numeric value or a combination of two or more of the name, the code, the character string, and the numeric value to be used to uniquely distinguish a certain target from a plurality of targets. The password is a code, a character string, a numeric value or a combination of two or more of the code, the character string, and the numeric value. The password is determined beforehand for authentication whether a user is an authorized user.

TABLE 2

| | |
|---|---|
| Use authority | Copy: Permitted |
| | Print: Permitted |
| | Facsimile: Not permitted |
| | Monochrome print: Permitted |
| | Color print: Not permitted |
| | Change: Not permitted |
| Information about | Remaining points: 180 |
| billing system | Rule applied when limit is reached: |
| | Execute up to current job |
| | Change: Permitted |
| IC card information | Dge723jw378gwht9w47gjws |
| | Change: Permitted |
| Delivery destination folder | . . . ¥suzuki¥doc |
| | Change: Permitted |
| Job acquisition information | Document server (168.192.1.0) |
| | Change: Permitted |
| . . . | . . . |

TABLE 2 illustrates one example of user setting information. The user setting information is information about a setting for each user 9 when the user 9 uses the electronic device 30. Examples of the user setting information includes use authority, information about the billing system 60, IC card information, a delivery destination folder, and job acquisition information. The use authority is information that indicates whether the user 9 has the authority to use the electronic device 30 on a function basis, and cannot be changed by the user. The information about the billing system 60 is information that is necessary or preferably present when the billing system 60 is used. The information about the billing system 60 includes remaining points for use of the billing system 60, and a rule to be applied when a limit is reached. The user 9 can use the electronic device 30 in a range of the remaining points. If the user 9 uses up the remaining points, the use of the electronic device 30 is restricted according to the rule to be applied when the limit is reached. The IC card information indicates a personal identification number (PIN) of an IC card. The delivery destination folder indicates a destination folder to which image data generated by scanning performed by the electronic device 30 is delivered. Basically, the delivery destination folder can be changed by the user. However, a flag for setting whether a change is permitted is set such that the change is restricted by the administrator.

The job acquisition information is information about a document server as an acquisition source from which the electronic device 30A acquires a user document. Basically, the job acquisition information can be changed by the user. However, a flag for setting whether a change is permitted is set such that the change can be restricted by the administrator.

In the directory server 50, general-purpose user setting information. (e.g., a mail address, user ID, a password, a facsimile number, affiliation, a class, and a name) that is not relevant to a type of the electronic device 30 is stored. In the user setting information, user setting information unique to the electronic device 30 and the user 9 is registered.

### (Function of Terminal Device 10)

The short-range wireless communication unit 24 communicates with each of the electronic device 30A and 30B to exchange various data. The short-range wireless communication unit 24 functions by control of the short-range wireless communication device 109 by execution of the program 108p by the CPU 106.

The general-purpose communication unit 23 communicates with the electronic device 30A to exchange various data. The general-purpose communication unit 23 functions by control of the communication OF 107 by execution of the program 108p by the CPU 106.

The operation receiving unit 21 receives various operations with respect to the terminal device 10. The operation receiving unit 21 functions by control of the input device 101 by execution of the program 108p by the CPU 106.

The display controller 22 generates a screen to serve as a user interface, and displays the user interface on the display device 102. The display controller 22 functions by control of the display device 102 by execution of the program 108p by the CPU 106.

The authentication information management unit 25 stores the authentication information 291 received by the operation receiving unit 21 in the storage unit 29. Moreover, the authentication information management unit 25 retrieves the authentication information 291 from the storage unit 29 to transmit the authentication information 291 to the electronic device 30A and/or 30B via the short-range wireless communication unit 24. Moreover, the authentication information management unit 25 caches (stores) the authentication information 291 acquired from the electronic device 30. The authentication information management unit 25 functions by execution of the program 108p by the CPU 106.

The user setting information management unit 26 acquires user setting information from the electronic device 30B, and stores the user setting information in the storage unit 29. Moreover, the user setting information management unit 26 transmits the user setting information 292 of the storage unit 29 to the electronic device 30A when the electronic device 30 is used. The user setting information management unit 26 functions by execution of the program 108p by the CPU 106.

### <<Electronic Device 30A>>

The electronic device 30A includes a general-purpose communication unit 41, a short-range wireless communication unit 42, an operation receiving unit 44, a display controller 45, and an authentication processor 47. Each of these functional units functions or performs an operation when a corresponding component illustrated in FIG. 5 operates based on a command from the CPU 106 according to the program 215p (a device authentication application) loaded to the RAM 212 from the HDD 215. However, some or all of the functions may be performed by a hardware circuit such as an IC, an LSI, an ASIC, and an FPGA.

Moreover, the electronic device 30A functions with the HDD 215, the RAM 212, the ROM 213, and the NVRAM 214. Moreover, the electronic device 30A includes a storage unit 49 for storing various information. In the storage unit 49, connection information 492 is stored. The connection information 492 is information for communication between the terminal device 10 and the electronic device 30A. Examples of the connection information 492 include an Internet Protocol (IP) address of the electronic device 30A, an encryption key of an access point of a wireless LAN, and an encryption method.

### (Function of Electronic Device 30A)

The short-range wireless communication unit 42 communicates with the terminal device 10 to exchange various data. The short-range wireless communication unit 42 functions by control of the short-range wireless communication device 207 by execution of the program 215p by the CPU 211.

The operation receiving unit 44 receives various operation with respect to the electronic device 30B. The operation receiving unit 44 functions by control of the operation panel 202 by execution of the program 215p by the CPU 211.

The display controller 45 generates a screen to serve as a user interface, and displays the user interface on the operation panel 202. The display controller 45 functions by control of the operation panel 202 by execution of the program 215p by the CPU 211.

The authentication processor 47 performs a process relating to authentication of the user 9. For example, the authentication processor 47 transmits the authentication information acquired from the terminal device 10 and an authentication request to the directory server 50, and acquires an authentication result from the directory server 50. The authentication processor 47 may perform authentication by using authentication information stored in a local DB.

The general-purpose communication unit 41 communicates with the electronic device 30B and the directory server 50 to exchange various data. The general-purpose communication unit 41 functions by control of the communication I/F 204 by execution of the program 215p by the CPU 211.

### <<Electronic Device 30B>>

The electronic device 30B includes a user setting information receiving unit 48, the general-purpose communication unit 41, the operation receiving unit 44, the display controller 45, a user setting information provider 462, the authentication processor 47, and the short-range wireless communication unit 42. A description of functions similar to the functions of the electronic device 30A is omitted. Each of these functional units functions or performs an operation when a corresponding component illustrated in FIG. 5 operates based on a command from the CPU 211 according to the program 215p (a device authentication application) loaded to the RAM 212 from the HDD 215. However, some or all of the functions may be performed by a hardware circuit such as an IC, an LSI, an ASIC, and an FPGA.

Similar to the electronic device 30A, the electronic device 30B includes a storage unit 49. A user setting information DB 493 of the electronic device 30B is set by the administrator 8. TABLE 3 illustrates the user setting information set by the administrator

TABLE 3

| Directory server | |
|---|---|
| communication information | IP address, Port number |
| General user use authority, | Copy: Permitted |
| use limit | Print: Permitted |
| | Facsimile: Not permitted |
| | Monochrome print: Permitted |
| | Color print: Not permitted |
| | Use limit: 100 |
| | Change: Not permitted |
| Guest user use authority | Copy: Permitted |
| | Print: Permitted |
| | Facsimile: Permitted |
| | Monochrome print: Permitted |
| | Color print: Permitted |
| | Change: Not permitted |
| Job acquisition information | IP address, port number |
| | Change: Permitted |
| Delivery destination folder | . . . ¥UTO¥ |
| | Change: Permitted |
| . . . | . . . |

TABLE 3 illustrates one example of user setting information of an initial state. The user setting information of the initial state is user setting information that has been initially set in each electronic device 30 by the administrator 8. Examples of the user setting information of the initial state include directory server communication information, general user use authority, a use limit, guest user use authority, job acquisition information, and a delivery destination folder. Out of such information, the directory server communication information is necessary if the directory server 50 performs user authentication. However, if the directory server 50 does not perform user authentication, the directory server communication information may not be needed.

The user setting information receiving unit 48 receives user setting information that is set by the administrator 8. The user setting information receiving unit 48 functions by control of an input device such as the operation panel 202, the communication I/F 204, and the external I/F 203 by execution of the program 215p by the CPU 211.

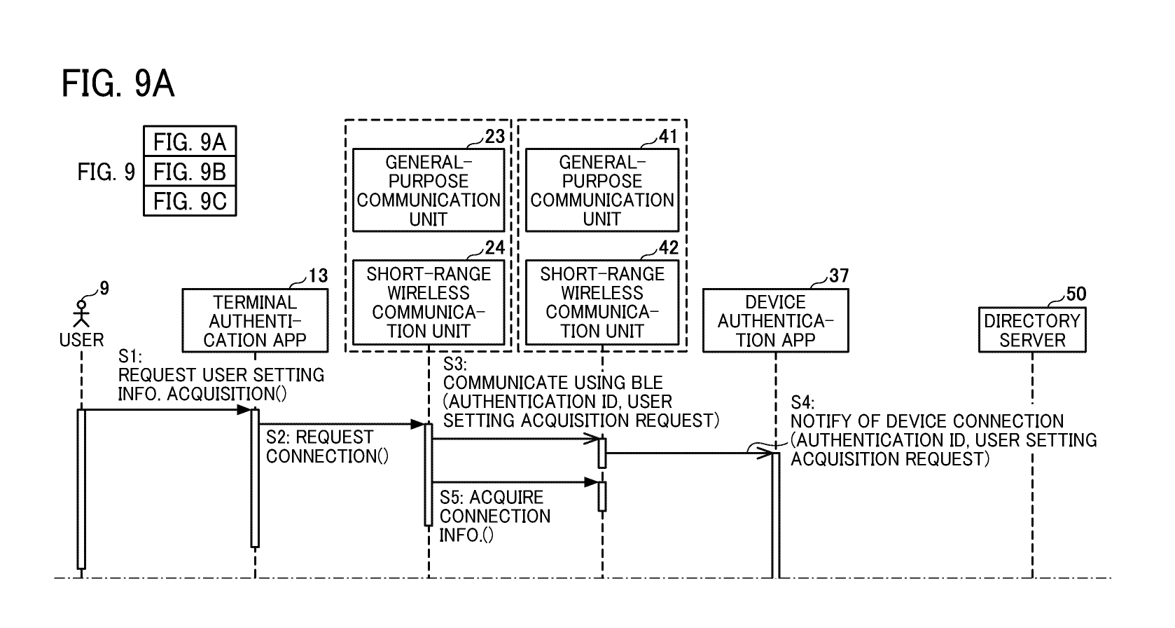

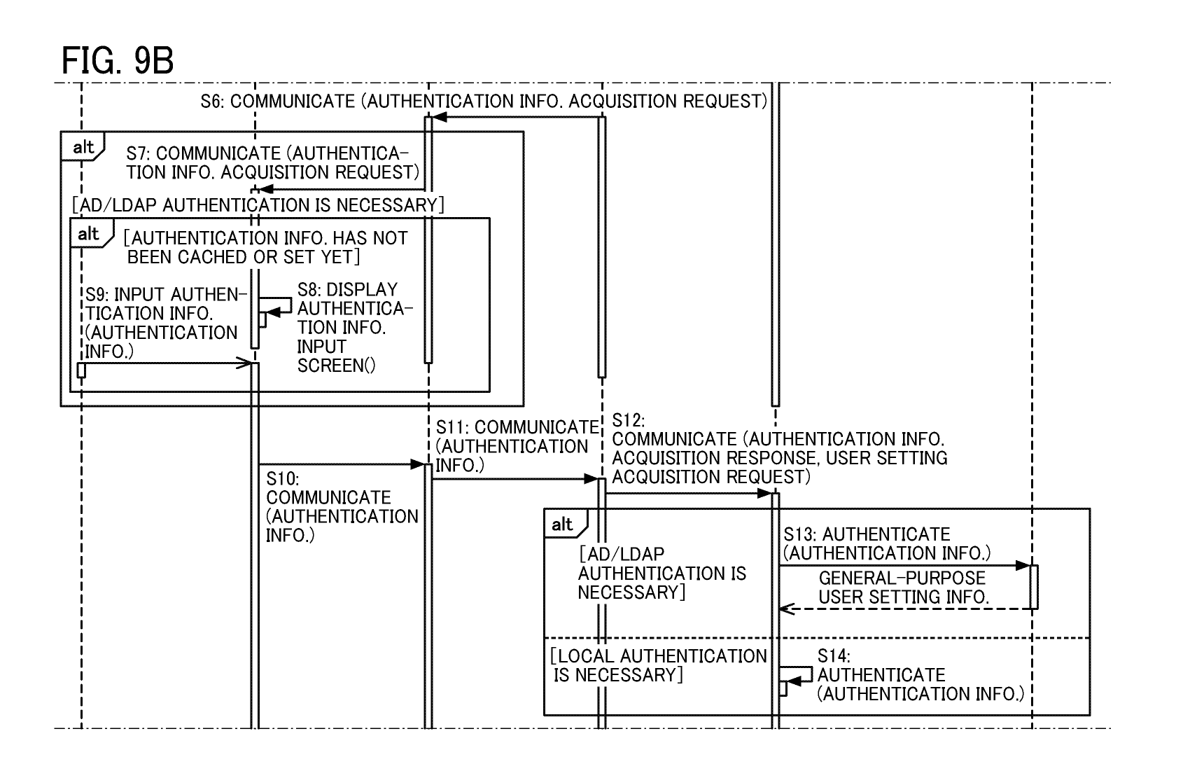

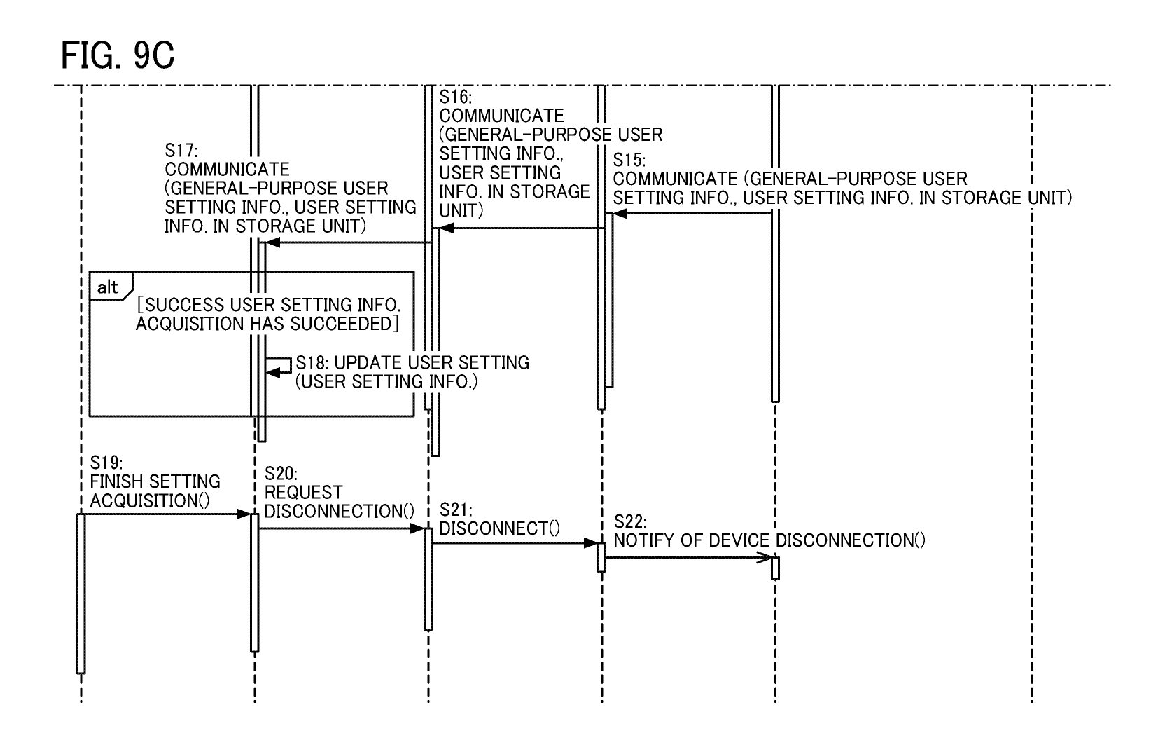

The user setting information provider 462 of the electronic device 30B distributes the user setting information DB 493 to the terminal device 10 of the user 9. The operation of the user setting information provider 462 is described in detail with reference to FIG. 9 that is divided into three diagrams of FIGS. 9A, 9B, and 9C for the sake of convenience. The user setting information provider 462 functions by control of the communication I/F 204 by execution of the program 215p by the CPU 211.

### <<Directory Server 50>>

The directory server 50 includes an authentication unit 51 and an authentication request receiving unit 52. Each of such functional units functions or performs an operation when a corresponding component illustrated in FIG. 4 operates based on a command from the CPU 106 according to the program 108p loaded to the RAM 104 from the SSD 108. However, some or all of the functions may be performed by a hardware circuit such as an IC, an LSI, an ASIC, and an FPGA.

The directory server 50 functions with the RAM 104 or the SSD 108, and includes a storage unit 59 for storing various information. The storage unit 59 stores an authentication information DB 591. TABLE 4 illustrates one example of information stored in the authentication information DB 591.

TABLE 4

| | | Mail | Affili- | Facsimile | | |
|---|---|---|---|---|---|---|
| User ID | Password | address | ation | # | Class | Name |
| suzuki@ | ******** | suzuki@ | Sales | 03-XXX- | B | Taro |
| sample.co.jp | | sample.co.jp | dept. | XXX | | Suzuki |

TABLE 4 schematically illustrates information stored in the authentication information DB 591. In the authentication information DB 591, information that is generally managed by the directory server 50 is registered. That is, user information that can be used regardless of a type of the electronic device 30 is registered in the authentication information DB 591. In particular, authentication information (user ID, and a password) of the user 9 is registered. Moreover, in the authentication information DB 591, general-purpose user setting information (e.g., mail address, and affiliation) that does not tend to be affected by a type of the electronic device 30 may be stored.

### <Setting of Initial User Setting Information by Administrator 8>

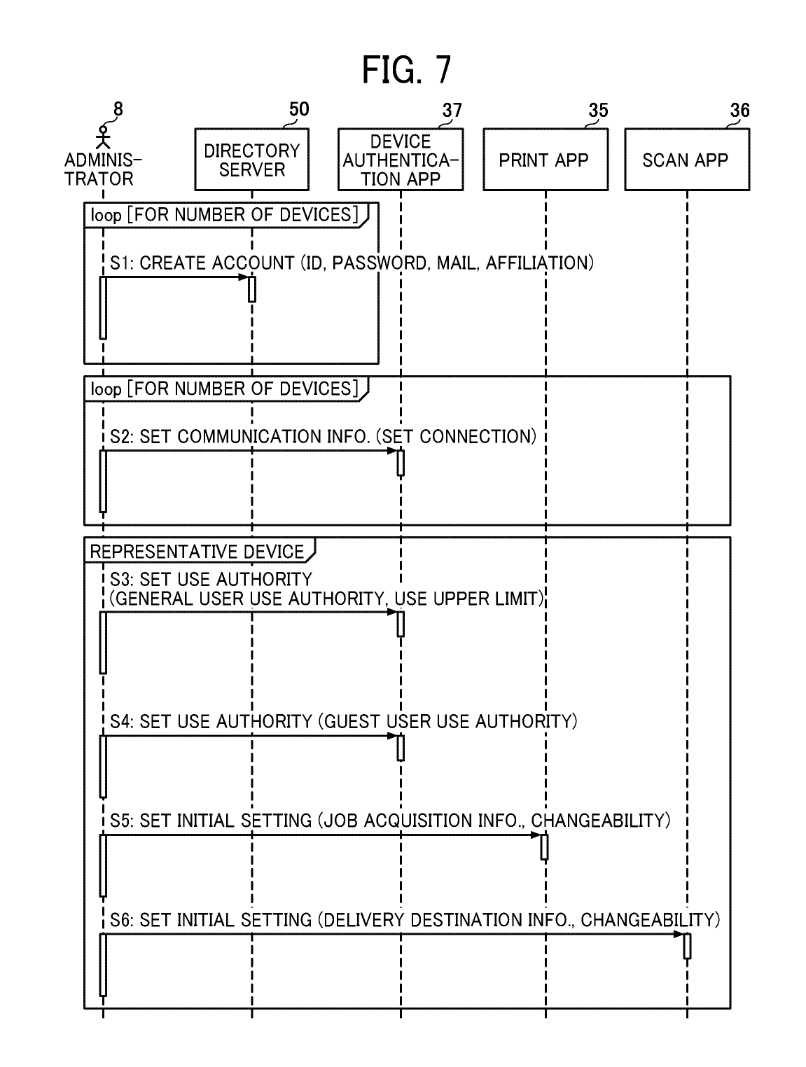

FIG. 7 is a sequence diagram illustrating one example of a procedure performed when the administrator 8 sets authentication information and initial user setting information.

In step S1, the administrator 8 creates an account with respect to the directory server 50. The account includes information illustrated in FIG. 4. That is, the account includes information about the user 9 such as an electronic mail address and affiliation that are generally managed, in addition to authentication information such as user ID and a password. The administrator 8 creates accounts for the number of users 9. The administrator 8 can create an account in a local DB of the electronic device 30 without using the directory server 50. Moreover, the administrator 8 can communicate with the directory server 50 by using a personal computer (PC) if the administrator 8 creates an account in the directory server 50 or the electronic device 30.

Moreover, the administrator 8 performs an initial setting of user setting information with respect to each electronic device 30.

Subsequently, a process of step S2 is performed with respect to each device.

In step S2, the administrator 8 first sets directory server communication information for communication with the directory server 50 in the terminal authentication application 13. Such setting is necessary if the directory server 50 is used. The administrator 8 can set authentication information of the electronic device 30 other than an IP address and a port number. Setting of the directory server communication information is performed for each electronic device 30.

In the following steps, setting of information is performed with respect to only the representative electronic device 30. However, setting of information may be performed with respect to each electronic device 30.

In step S3, the administrator 8 sets general user use authority and a use limit in the terminal authentication application 13. The general user use authority and the use limit are not changeable.

In step S4, the administrator 8 sets guest user use authority in the terminal authentication application 13. Since a guest user is unlikely to make many prints, there is no use limit. However, a use limit may be set. The guest user use authority is not changeable.

In step S5, the administrator 8 sets job acquisition information and changeability in the document management application 14. The job acquisition information is changeable. Such setting can be the same for all users since each user can perform a setting.

Subsequently, in step S6, the administrator 8 sets a delivery destination folder and changeability in the scan application 36. The delivery destination folder is changeable. Such setting can be the same for all users since each user can perform a setting.

Each of steps S3 through S6 may not be required. If the directory server 50 is not used, the process of step S2 is not necessary.

### <Setting of Terminal Authentication Application by User 9>

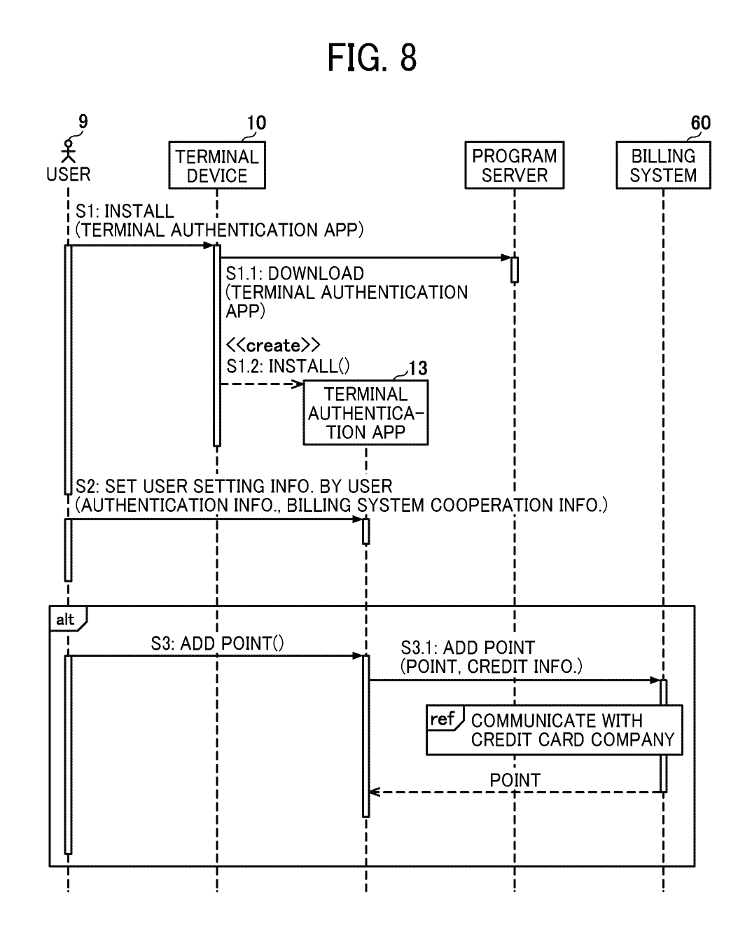

FIG. 8 is a sequence diagram illustrating one example of a procedure performed when the user 9 sets the terminal authentication application 13 in the terminal device 10. In steps S1 through S1.2, the user 9 downloads the terminal authentication application 13, and installs the terminal authentication application 13 in the terminal device 10. The user 9 downloads and installs the document management application 14 and the device management application 15 as necessary. In step S2, the user 9 sets information that is necessary when the electronic device 30 is used. For example, in a case where authentication information is input beforehand, the user 9 does not need to input the information each time the user 9 uses the electronic device 30. Moreover, in a case where billing is charged to the billing system 60, the user 9 sets a uniform resource locator (URL) of the billing system 60 beforehand.

In step S3, the user 9 adds a point for use of the electronic device 30.

In step S3.1, the terminal authentication application 13 requests addition of the point from the billing system 60. The addition of the point includes a point to be added and credit information. The credit information is a credit card number, and is transmitted to a credit card company. In the sequence diagram illustrated in FIG. 8, a detailed process of the credit information transmission is omitted. If the user 9 does not need to add a point, point addition is not necessarily executed. In the terminal authentication application 13, a remaining point that is set according to a billing amount by the billing system 60 is set. The remaining point becomes a part of the user setting information.

<Copy of User Setting Information by Terminal Device 10>

Next, a procedure performed when the user 9 copies user setting information in the electronic device 30 to the terminal device 10 is described with reference to FIG. 9.

When communication is started, the terminal device 10 and the electronic device 30B communicate using Bluetooth Low Energy (BLE). However, such communication is one example. In Bluetooth Low Energy, a device that provides a service (e.g., the electronic device 30B) is called a peripheral, whereas a device that uses the service (e.g., the terminal device 10) is called a central. A relationship between the peripheral and the center is not fixed, and can be reversed. When the terminal device 10 receives an advertised packet transmitted by the electronic device 30B and checks service content (a universally unique identifier (UUID)), the terminal device 10 connects communication with the electronic device 30B.

In step S1, the user 9 operates the terminal authentication application 13 to acquire the user setting information. The operation receiving unit 21 receives the operation performed by the user 9.

In step S2, the user setting information management unit 26 of the terminal device 10 requests the user setting information from the electronic device 30B via the short-range wireless communication unit 24.

In step S3, the short-range wireless communication unit 24 of the terminal device 10 transmits authentication ID and a user setting information request to the short-range wireless communication unit 42 of the electronic device 30B by communication using Bluetooth Low Energy. The authentication ID is identification information for identifying a short-range wireless communication device. Short-range wireless communication devices communicate with each other by identifying each other with the authentication ID.

In step S4, the short-range wireless communication unit 42 of the electronic device 30B receives the authentication ID and the user setting information request. The short-range wireless communication unit 42 delivers the authentication ID and the user setting information request to the device authentication application 37. Accordingly, the device authentication application 37 ascertains that the user setting information has been requested.

In step S5, the short-range wireless communication unit 24 of the terminal device 10 acquires connection information. 491 from the electronic device 30B. The acquisition of the connection information 491 enables the terminal device 10 to communicate with the electronic device 30B by a wireless LAN having higher speed than Bluetooth Low Energy. However, the communication method does not need to be changed in step S5. The communication can be performed using Bluetooth Low Energy up to an authentication process described below.

In step S6, the authentication processor 47 of the electronic device 30B requests acquisition of authentication information of the user 9 from the terminal device 10 via the general-purpose communication unit 41 to authenticate the user 9.

In step S7, the general-purpose communication unit 23 of the terminal device 10 receives the authentication information acquisition request, and delivers the authentication information acquisition request to the terminal authentication application 13.

Subsequent steps S8 and S9 are executed if authentication information is not set in the terminal device 10 by the user 9 or authentication information is not cached. That is, steps S8 and S9 are executed if the authentication information 291 is not stored in the storage unit 29.

In step S8, the display controller 22 of the terminal device 11) displays an authentication information input screen on the display device 102.

In step S9, the user 9 inputs the authentication information.

In step S10, the authentication information management unit 25 of the terminal device 10 delivers the authentication information input by the user 9 or retrieved from the storage unit 29 to the general-purpose communication unit 23.

In step S11, the general-purpose communication unit 23 of the terminal device 10 delivers the authentication information to the general-purpose communication unit 23.

In step S12, the general-purpose communication unit 41 of the electronic device 30B receives the authentication information, and delivers the authentication information to the authentication processor 47.

Next, a process in either step S13 or S14 is executed.

A process in step S13 is executed if the directory server 50 performs authentication. In step S13, the authentication processor 47 transmits an authentication request and the authentication information to the directory server 50. The authentication request receiving unit 52 of the directory server 50 receives the authentication request, and allows the authentication unit 51 to perform the authentication. The authentication unit 51 determines whether authentication succeeds based on whether a set of user ID and a password in the authentication request is stored in the authentication information DB 591. In the present exemplary embodiment, a description is given of a case in which authentication has succeeded. The authentication request receiving unit 52 transmits the authentication information corresponding to the user ID and general purpose user setting information to the electronic device 30B.

A process in step S14 is executed, if the authentication information is stored in a local DB. In step S14, the authentication processor 47 performs authentication using the authentication information in the local DB.

In step S15, the authentication processor 47 of the electronic device 30B delivers the general-purpose user setting information and the authentication information acquired from the directory server 50, and the user setting information retrieved from the storage unit 49 to the general-purpose communication unit 41.

In step S16, the general-purpose communication unit 41 of the electronic device 30B transmits the user setting information retrieved from the storage unit 49, the authentication information, and the general-purpose user setting information to the terminal device 10.

In step S17, the general-purpose communication unit 23 of the terminal device 10 receives such information, and delivers the information to the terminal authentication application 13. Thus, the terminal device 10 can acquire user setting information that is set by the administrator 8 and unique to a type of the electronic device 30.

In step S18, the authentication information management unit 25 of the terminal device 10 caches (stores) the authentication information in the storage unit 29. Moreover, the user setting information management unit 26 caches (stores) the user setting information retrieved from the storage unit 49 and the general-purpose user setting information in the storage unit 29. In the storage unit 29, the user setting information retrieved from the storage unit 49 and the general-purpose user setting information are not distinguished from each other.

In step S19, the user 9 operates the terminal device 10 to finish the setting of the user setting information. Herein, the user 9 holds the terminal device 10 over a short-range wireless communication apparatus of the electronic device 30B again, or the user 9 simply moves the terminal device 10 away from the electronic device 30A.

In step S20, upon receipt of the operation, the operation receiving unit 21 of the terminal device 10 requests the general-purpose communication unit 23 to disconnect the communication.

In step S21, the general-purpose communication unit 23 of the terminal device 10 requests the electronic device 30 to disconnect the communication.

In step S22, the general-purpose communication unit 41 of the electronic device 30B notifies the authentication processor 47 of the disconnection. The communication using Bluetooth Low Energy can be continued during the processes illustrated in FIG. 9, and the communication using Bluetooth Low Energy can be disconnected in step S22.

Accordingly, in the terminal device 10 of the user 9, user setting information that is conventionally managed by an authentication server is stored. Therefore, the server-less configuration can reduce work of the administrator 8 in storing user setting information in each electronic device 30.

### <Change in User Setting Information of Terminal Device by User>

A user can optionally change user setting information of the terminal device 10. In such a case, a setting about changeability set by the administrator 8 needs to be set to “change permitted”.

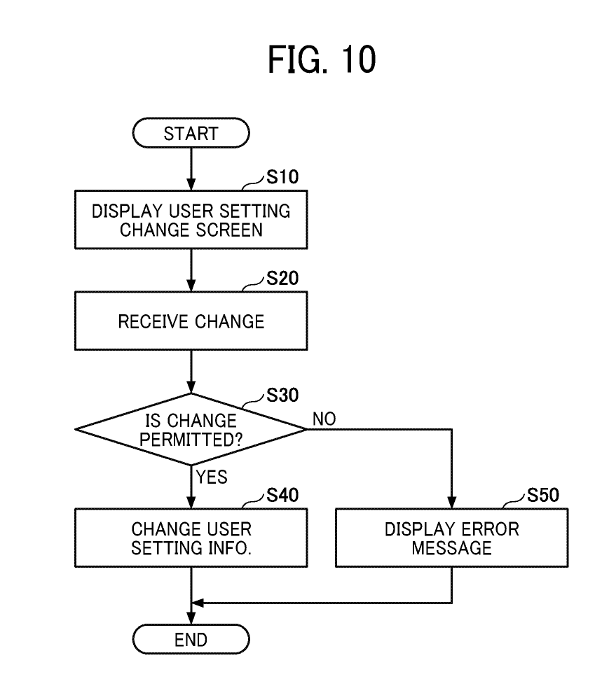

FIG. 10 is a diagram illustrating one example of a change in the user setting information stored in the terminal device 10. In step S10, when the user operates the terminal device 10 to display a user setting change screen, the operation receiving unit 21 of the terminal device 10 receives the operation and displays the user setting change screen on the display device 102.

In step S20, the user allows the items in TABLE 2 and the current setting values to be displayed on the user setting change screen, and inputs a changed setting value. The operation receiving unit 21 receives the change.

In step S30, when the change is received by the operation receiving unit 21, the user setting information management unit 26 determines whether the item set by the user is “change permitted”. For example, a change in each of use authority, information about billing system, and IC card information is not permitted, whereas a change in each of a delivery destination folder and job acquisition information is permitted.

If the user setting information management unit 26 determines that a change in the item is permitted (YES in step S30), the process proceeds to step S40 in which the user setting information management unit 26 changes the user setting information.

If the user setting information management unit 26 determines that a change in the item is not permitted (NO in step S30), the process proceeds to step S50 in which the user setting information management unit 26 displays an error message indicating that a change is not permitted on the user setting change screen.

On the user setting change screen, each item can be displayed with indication of whether a change is permitted. Alternatively, when a user setting change screen is to be displayed, the user setting change screen can be controlled such that a change-permitted item is displayed and a change-not-permitted item is not displayed based on whether a change in each items is permitted.

### <Login Process and Transmission of User Setting Information>

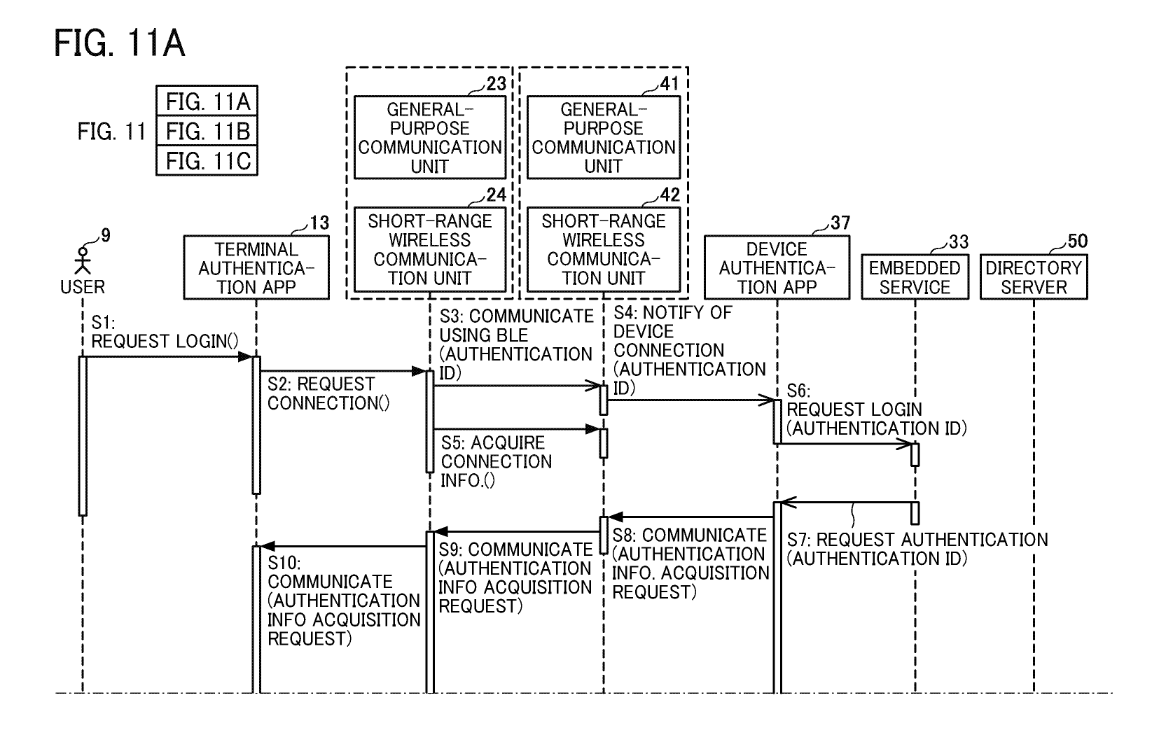

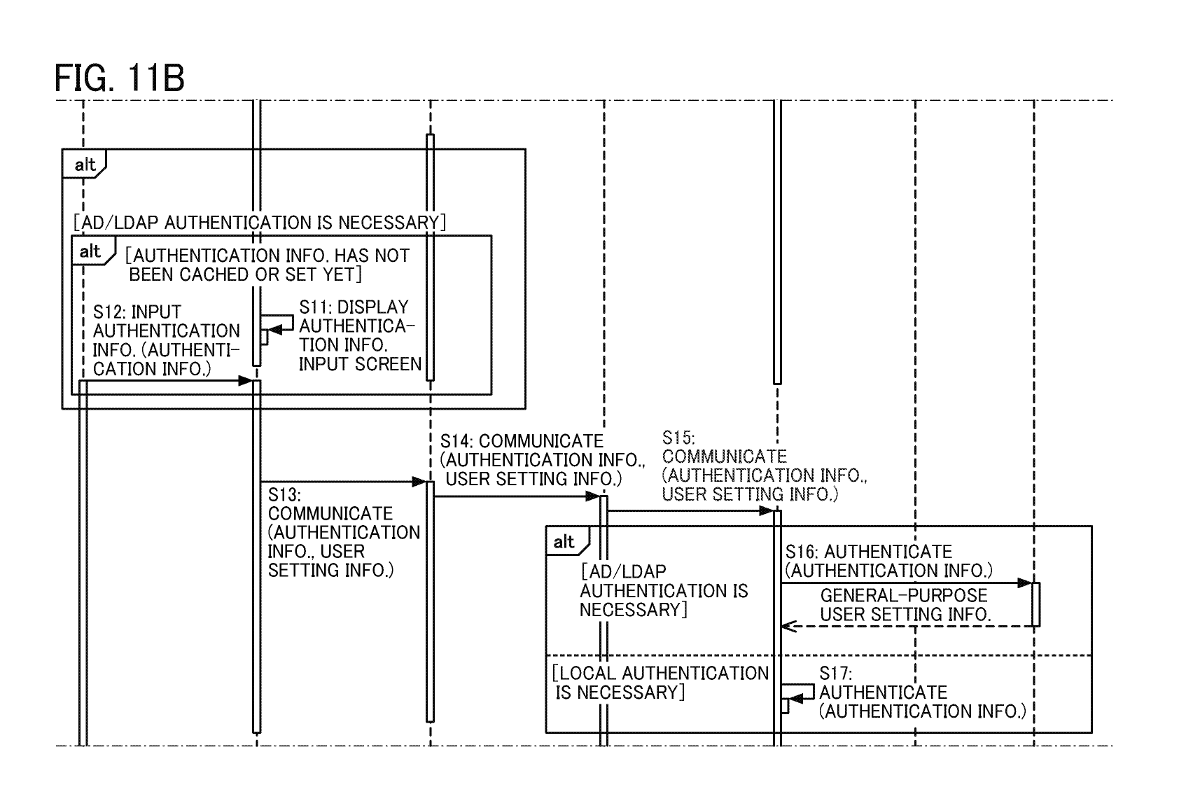

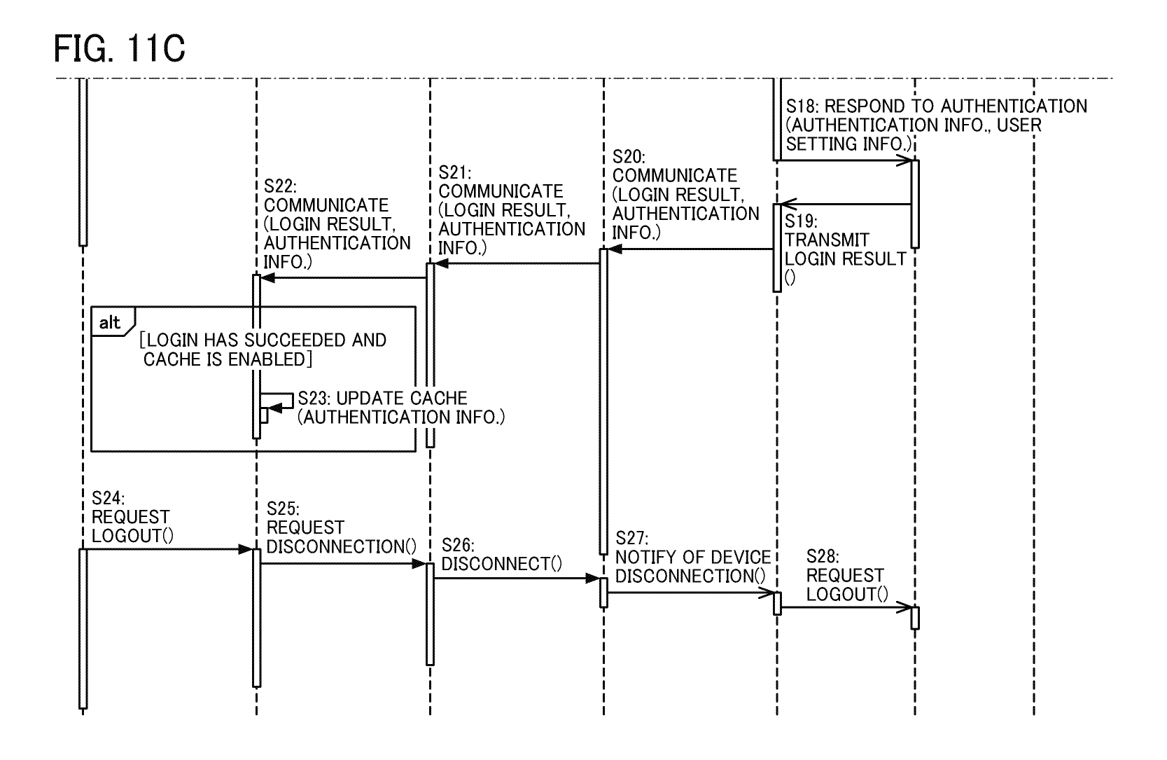

FIG. 11 is a sequence diagram illustrating one example of a procedure performed when the user 9 logs in the electronic device 30A to transmit the user setting information of the terminal device 10 to the electronic device 30A. FIG. 11 is divided into three diagrams of FIGS. 11A, 11B, and 11C for the sake of convenience. In FIG. 11, processes different from processes in FIG. 9 are mainly described.

In steps S1 through S5, the user 9 operates the terminal authentication application 13 to perform a login operation. The operation receiving unit 21 receives the operation of the user 9. A subsequent communication connection process is similar to the process described in FIG. 9. However, since a login request is issued in FIG. 11, the device authentication application 37 issues a login request to the embedded service 33.

In step S6, the authentication processor 47 of the electronic device 30A issues a login request to the embedded service 33. Then, an authentication process begins. Processes in steps S7 through S12 are similar to the processes described in FIG. 9.

In step S13, the authentication information management unit 25 of the terminal device 10 retrieves authentication information from the storage unit 29 (assume that the authentication information is already cached). Moreover, since the user setting information is necessary for use of the electronic device 30A, the user setting information management unit 26 retrieves the user setting information from the storage unit 29. In step S14, the general-purpose communication unit 23 of the terminal device 10 transmits the authentication information and the user setting information to the electronic device 30A. An authentication process in steps S15 through S17 can be similar to the process described in FIG. 9.

In step S18, the authentication processor 47 of the electronic device 30A delivers the authentication information and the user setting information acquired from the terminal device 10 to the embedded service 33. Thus, the embedded service 33 uses the user setting information, so that suitable control is performed when the user uses the electronic device 30A. For example, a function can be restricted by use authority, or billing can be performed.

Subsequent processes in steps S19 through S22 are performed to transmit a login result (an authentication result), and can be similar to the processes described in FIG. 9. However, in FIG. 11, authentication information indicating that authentication has succeeded (authentication information managed by the directory server 50) is transmitted from the electronic device 30A to the terminal device 10. Moreover, general-purpose user setting information managed by the directory server 50 can be transmitted.

In step S23, the authentication information management unit 25 of the terminal device 10 caches (stores) the authentication information transmitted from the electronic device 30A in the storage unit 29. Accordingly, new authentication information is cached, so that the terminal device 10 can retain updated authentication information. Even if the user 9 operates another electronic device 30 (a device other than the electronic device 30A), the user 9 can log in by a similar manner. In the server-less configuration, although the electronic device 30A can cache authentication information, the latest authentication information is not cached if the user 9 operates another electronic device 30 (a device other than the electronic device 30A). In such a case, the user 9 may not be able to log in.

A mechanism for automatically updating authentication information includes a method by which the administrator 8 first sets a new password in the directory server 50 (or a local DB of the electronic device 30A), and an old password is overwritten with the new password when the user 9 logs in. Since the new password is transmitted to the terminal device 10, the user 9 can log in using the new password at next login. The user 9 does not need to change or input the password.

A disconnection process in steps S24 through S28 can be similar to a disconnection process described in FIG. 9.

In step S14, the terminal device 10 can transmit login classification to the electronic device 30A. The login classification distinguishes a general user from a guest user. The electronic device 30A can refer to use authority corresponding to the general user or the guest user to determine use authority of a user.

In step S14, the terminal device 10 can notify the electronic device 30A of a ticket such as a Kerberos authentication ticket for single sign on. In such a case, when login succeeds, the electronic device 30A transmits a login result and the ticket such as a Kerberos authentication ticket to the terminal device 10. Accordingly, in a case where the user uses other services from the terminal device 10 via the electronic device 30A, single sign-on can be performed. Moreover, in a case where the user logs in the electronic device 30A again, the user can be saved from having to input the authentication information again. In the server-less configuration, the IC card and the user setting information need to be registered for each electronic device 30 in a case where user setting information and an IC card are not linked. Hence, such advantage is significant.

### <Job Execution>

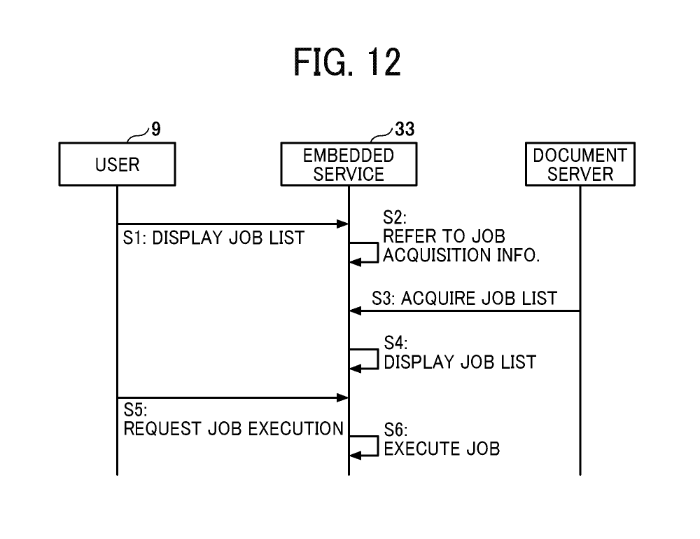

FIG. 12 is a sequence diagram illustrating one example of a procedure performed when a job using user setting information is executed. In step S1, the user 9 operates the electronic device 30A to display a job list. In step S2, upon receipt of the operation, the operation receiving unit 44 of the electronic device 30A notifies the embedded service 33 of the contents of the operation. The embedded service 33 refers to job acquisition information of the user setting information set in step S18 of FIG. 11. In step S3, the embedded service 33 acquires the job list of the user from the document server set in the job acquisition information. Since the user is already authenticated, the embedded service 33 transmits the user ID to acquire, for example, a file name associated with the user 9. In step S4, the display controller 45 of the electronic device 30A displays the job list on the operation panel 202. In step S5, the user 9 selects a job from the job list to input a request for job execution. In step S6, the operation receiving unit 44 of the electronic device 30A receives the operation, and the embedded service 33 executes the job.

Accordingly, the electronic device 30A can operate based on the user setting information acquired from the terminal device 10. Control can be performed based on use authority, billing system information, and a delivery destination folder, in addition to the job acquisition information.

### <User Setting Information Verification Using Hashes>

In a case where the authentication server manages user setting information, the authentication server has a mechanism for preventing user setting information from intrusion from an external unit. Hence, manipulation of the user setting information is difficult for a third party. On the other hand, in a case where the terminal device 10 manages user setting information in a server-less configuration, the user 9 may intentionally or mistakenly edit user setting information. Information that must not be directly edited by the user 9 includes the use authority of the electronic device 30. In a case where use authority of the terminal device 10 is edited by the user 9, the user 9 can use a function that cannot be originally used by the user 9. Accordingly, as described below, the electronic device 30 verifies the user setting information by using user setting information hashes.

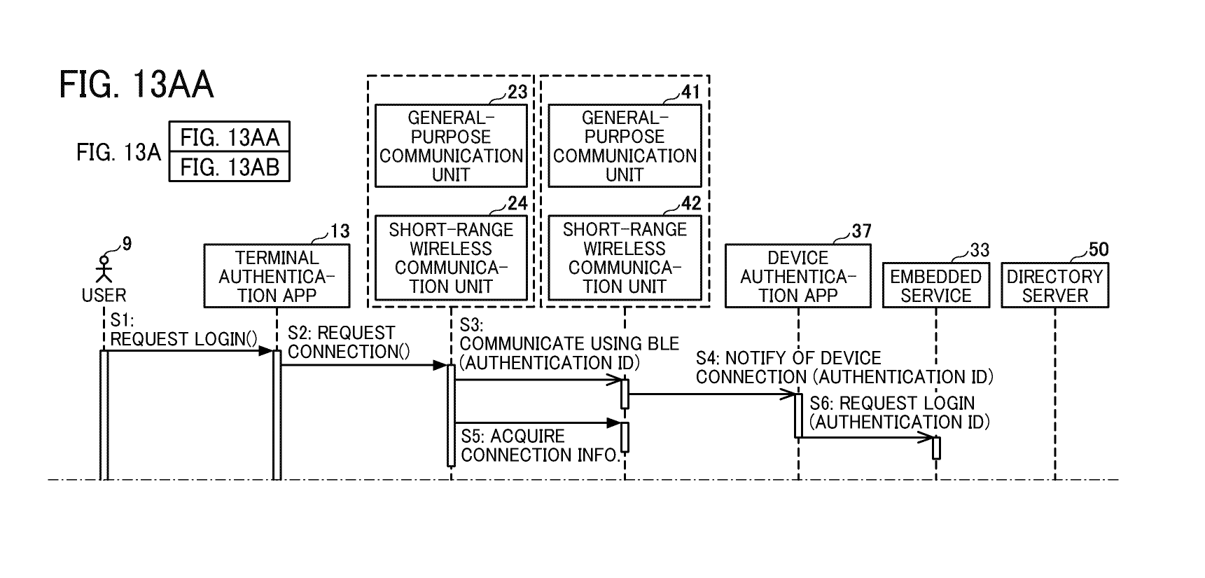

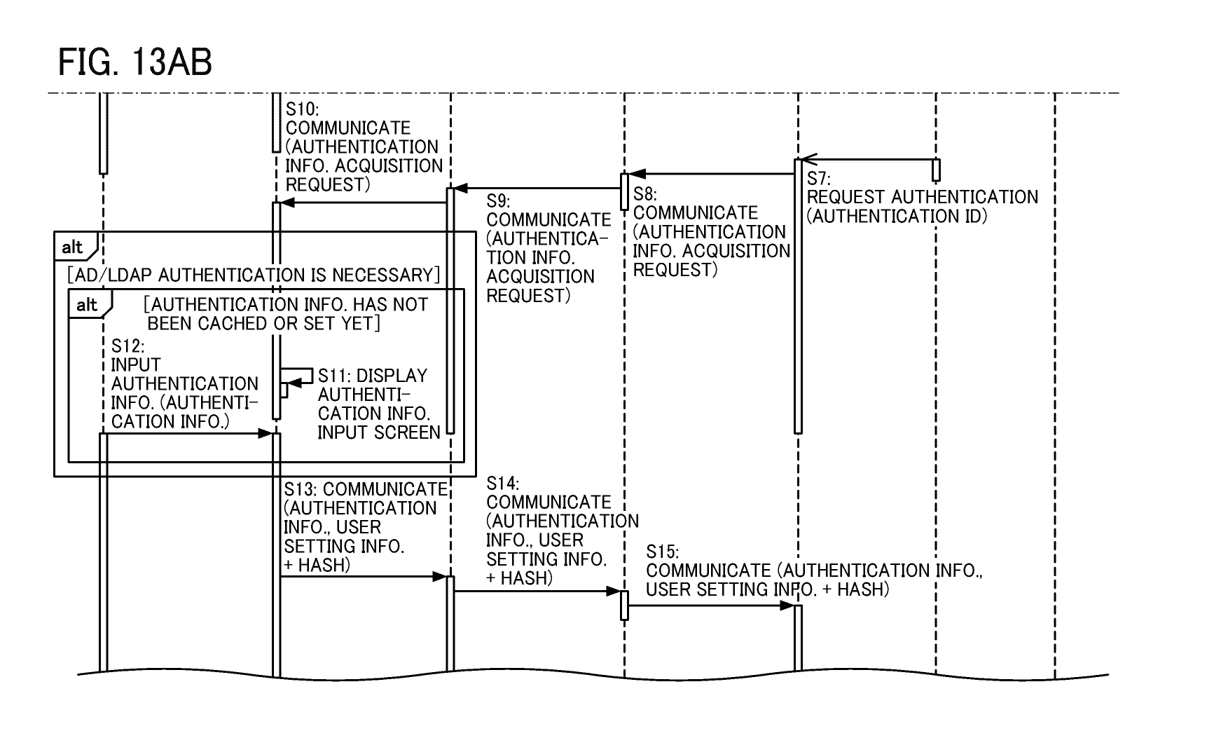

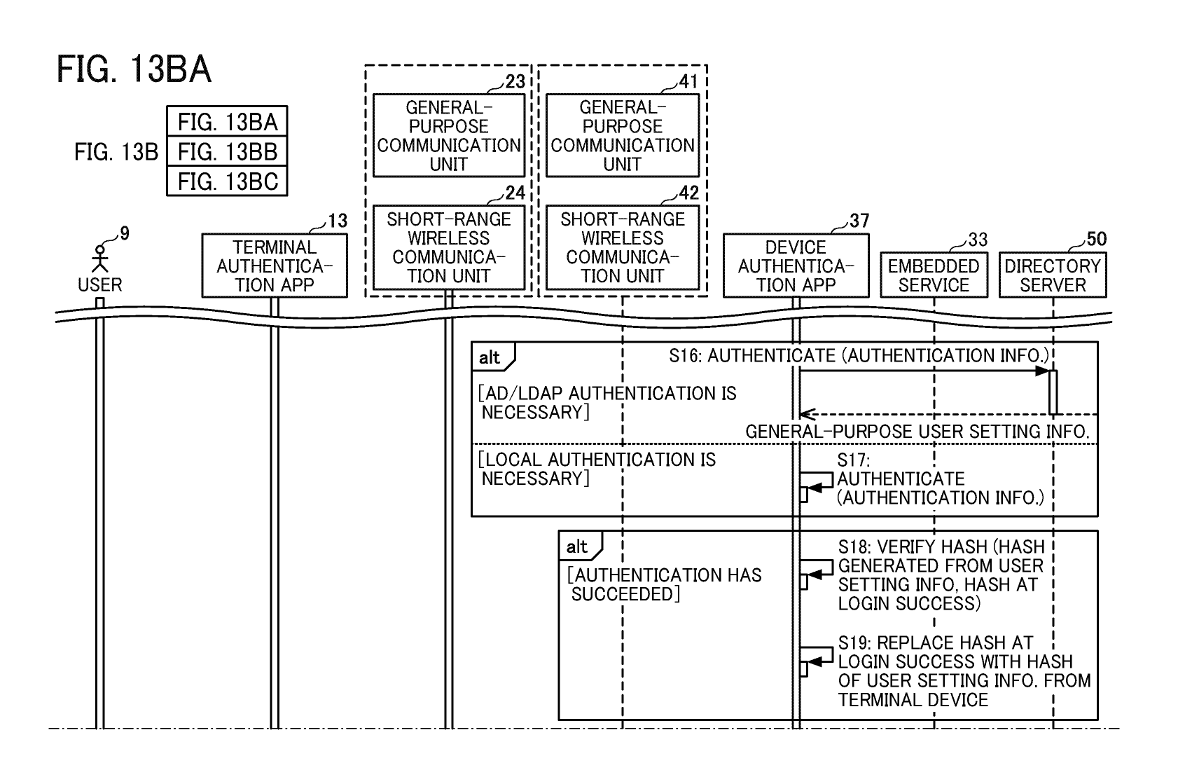

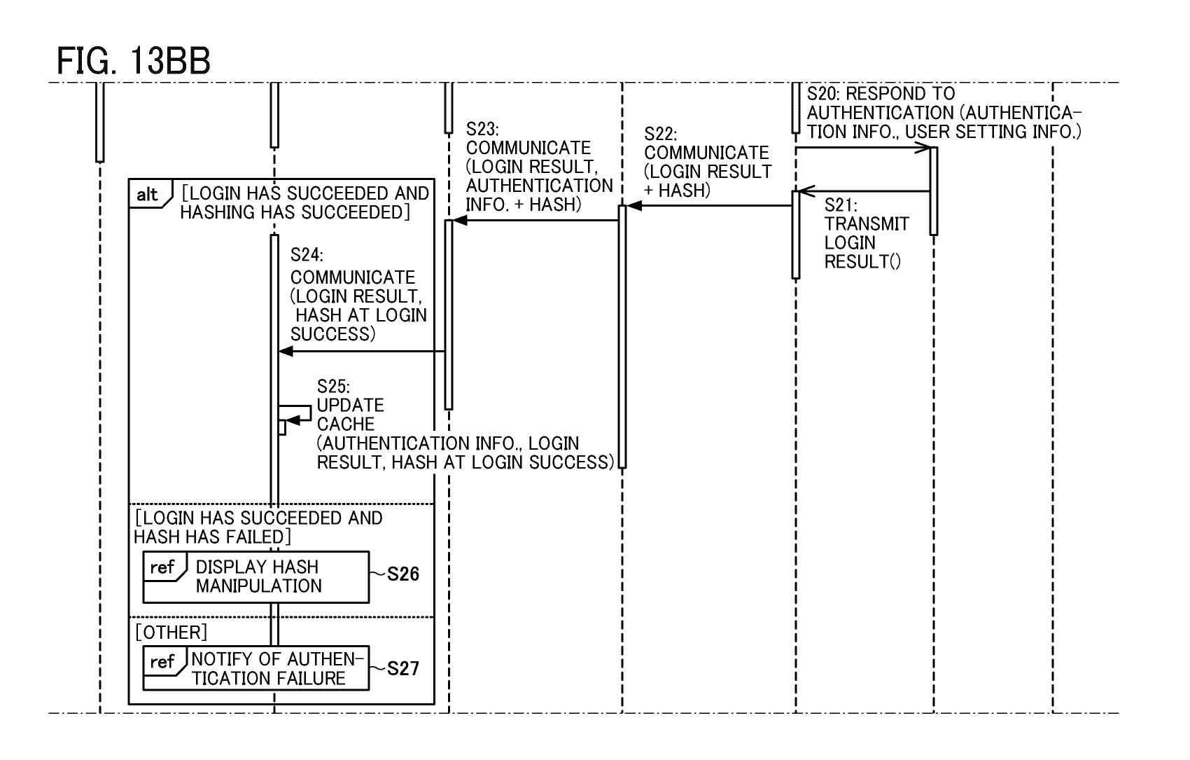

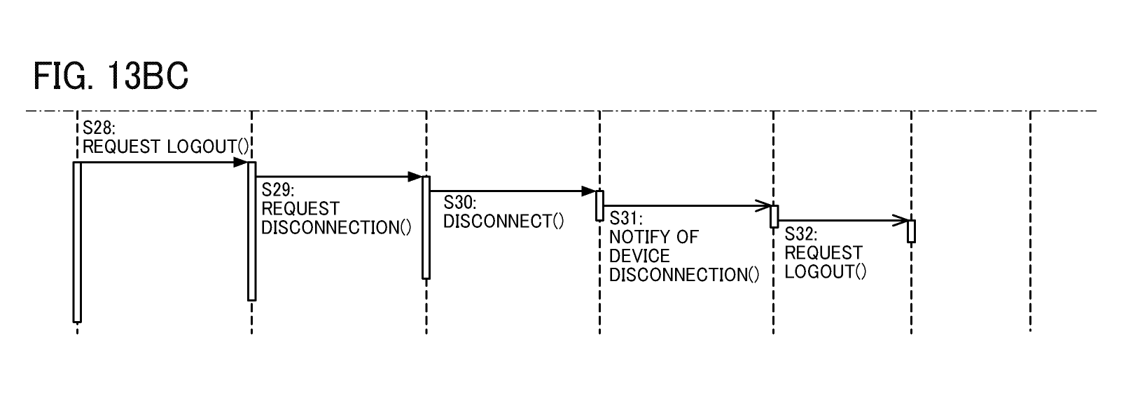

FIGS. 13A and 13B are sequence diagrams illustrating one example of a procedure performed when the user 9 logs in the electronic device 30A to transmit the user setting information in the terminal device 10 to the electronic device 30A. FIG. 13A is divided into two diagrams of FIGS. 13AA and 13AB, whereas FIG. 13B is divided into three diagrams of FIGS. 13BA, 13BB and 13BC for the sake of convenience. In FIGS. 13A and 13B, processes different from processes in FIG. 11 are mainly described.

In FIG. 13A, processes in steps S1 through S12 are substantially the same as the processes in FIG. 11. In step S13, the authentication information management unit 25 of the terminal device 10 transmits has functions of the user setting information acquired from the electronic device 30A at login success, the authentication information, and the user setting information to the electronic device 30A via the general-purpose communication unit 23.

An authentication process in steps S14 through S17 is substantially the same as the process described in FIG. 11. After the authentication, the device authentication application 37 verifies the hash of the user setting information. The hash can be created only from information that cannot be edited by the user out of the user setting information.

If the authentication succeeds, processes in steps S18 and S19 are performed. In step S18, the authentication processor 47 of the electronic device 30A verifies the hash. The authentication processor 47 compares the hash of the user setting information (transmitted by the electronic device 30A) at login success with the hash created from the user setting information transmitted from the terminal device 10. If both pieces of the hash are equal, the user setting information is not manipulated. Hence, the authentication processor 47 permits the user to log in, and a subsequent process is performed. In step S19, the authentication processor 47 of the electronic device 30A replaces the hash at login success with the hash of the user setting information transmitted from the terminal device 10.

The electronic device 30 transmits a login result (a login failure) to the terminal device 10 without an authentication failure process in step S20.

Processes in steps S20 and S21 can be similar to the process in steps S18 and S19 described in FIG. 11. In step S22, the general-purpose communication unit 41 of the electronic device 30A transmits the login result and the hash of the user setting information at login success to the terminal device 10. Processes in steps S23 and S24 can be similar to the process in steps S21 and S22 described in FIG. 11.

In step S25, if login has succeeded and hash authentication has succeeded, the user setting information management unit 26 of the terminal device 10 updates the hash of the user setting information. Moreover, the authentication information management unit 25 caches (stores) the authentication information and the login result in the storage unit 29.

In step S26, if login has succeeded and hash verification has failed, there is a possibility that the user setting information has been manipulated. Thus, the terminal device 10 notifies the user 9 that the user setting information is manipulated although authentication has succeeded. The user 9 reports to the administrator 8, so that the user 9 can log in.

In step S27, if other cases occur (the user cannot log in), the terminal device 10 notifies the user 9 of an authentication failure.

Accordingly, the electronic device 30A performs verification on the hash of the user setting information at login success, so that edition of user setting information that should not be edited by the user can be detected.

### <Management of User Setting Information to NFC>

Even if the user 9 does not have the terminal device 10, the similar process can be performed as long as the user 9 has an IC card. The IC card has a function of communicating with an IC card reader of the electronic device 30, and can store authentication information and user setting information.

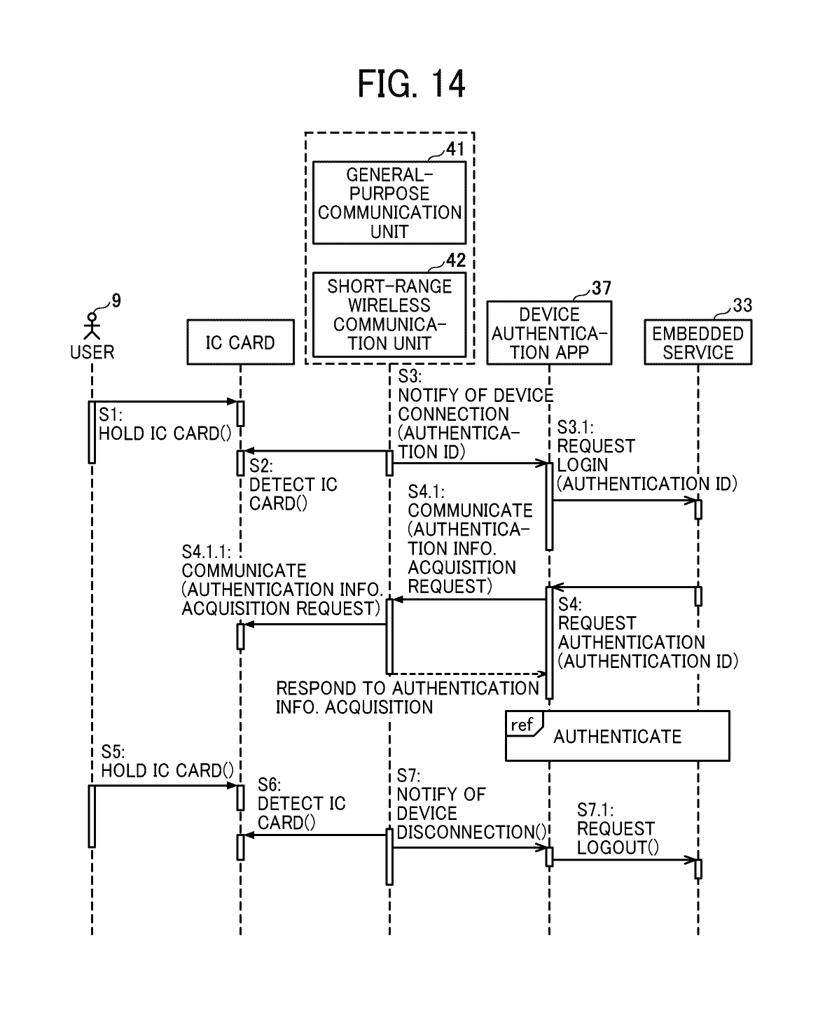

FIG. 14 is a sequence diagram illustrating one example of an authentication process using an IC card. In step S1, the user 9 holds an IC card close to the short-range wireless communication device 207 of the electronic device 30. In step S2, the short-range wireless communication unit 42 of the electronic device 30 detects the IC card. In step S3, the short-range wireless communication unit 42 of the electronic device 30 delivers authentication II) to the device authentication application 37. The authentication ID is identification information of the IC card. In step S3.1, the authentication processor 47 of the electronic device 30 delivers a login request to the embedded service 33. In step S4, the embedded service 33 delivers an authentication request to the device authentication application 37. In steps S4.1 and S4.1.1, the authentication processor 47 of the electronic device 30 requests the authentication information from the IC card via the short-range wireless communication unit 42.

Accordingly, the authentication processor 47 of the electronic device 30A can acquire the authentication information and the user setting information, and perform authentication using the directory server 50 or the local DB. A process to be performed after the authentication can be similar to the process described in FIG. 11 or 13B.

Accordingly, an IC card can be used instated of the terminal device 10. However, the user 9 may store optional information in an optional area of the IC card. In such a case, the IC card can be an obstacle when the user 9 uses the IC card in another system. Thus, in the terminal device 10 in which an IC card such as an NFC is mounted, the terminal device 10 preferably stores authentication information and user setting information, not from an IC card portion.

### CONCLUSION

In the electronic device system 100 according to the present exemplary embodiment, since the terminal device 10 manages user setting information, the administrator 8 does not need to register user setting information of all users who use the electronic device 30 in local DBs of all the electronic devices 30. Thus, a burden on the administrator 8 can be reduced.

### Other Exemplary Embodiments

Other exemplary embodiments are described.

For example, when a user uses an electronic device 30, the used point is transmitted to a billing system although such an example is not described in the above exemplary embodiment. Since a device authentication application transmits the used point to a terminal authentication application, the terminal authentication application can update the remaining points. Hence, the billing system and the remaining points of the terminal authentication application can be synchronized.

In the above exemplary embodiment, the storage unit 29 is one example of a memory, and the general-purpose communication unit 23 is one example of a sender. The general-purpose communication unit 41 is one example of a receiver, and the authentication processor 47 is one example of an authentication processor. Moreover, the embedded service 33 is one example of an electronic device controller, and the user setting information DB 493 is one example of a user setting information memory. The user setting information management unit 26 is one example of a user setting information management unit.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

The present disclosure has been described above with reference to specific exemplary embodiments but is not limited thereto. Various modifications and enhancements are possible without departing from scope of the disclosure. It is therefore to be understood that the present disclosure may be practiced otherwise than as specifically described herein. For example, elements and/or features of different illustrative exemplary embodiments may be combined with each other and/or substituted for each other within the scope of the present disclosure.

What is claimed is:

1. An electronic device system comprising:
an electronic device; and
a terminal device including:
a memory to store user setting information about a setting of the electronic device; and
a sender to transmit a login request and the user setting information to the electronic device,
the electronic device including:
a receiver to receive the login request and the user setting information from the terminal device;
an authentication processor to perform a process relating to user authentication by using authentication information included in the login request; and
an electronic device controller to control the electronic device according to the user setting information if the user authentication performed by the authentication processor succeeds.

2. The electronic device system according to claim 1, wherein the electronic device includes a user setting information memory to store the user setting information of each of multiple users,
wherein the terminal device includes a user setting information management unit that requests the authentication information and the user setting information of a user from the electronic device and acquires the user setting information from the electronic device to store the acquired user setting information in the memory, and
wherein, if the user authentication performed by the authentication processor succeeds, the electronic device transmits the user setting information of the user to the terminal device.

3. The electronic device system according to claim 2, wherein, if the user authentication performed by the authentication processor succeeds with respect to the login request, the authentication processor transmits hash of the user setting information to the terminal device, the user setting information management unit of the terminal device stores the hash of the user setting information, and the sender transmits the hash, the login request, and the user setting information to the electronic device, and
wherein, if the user authentication performed by the authentication processor succeeds with respect to the login request, the authentication processor compares hash created from the user setting information transmitted from the electronic device with the hash transmitted from the electronic device, and the authentication processor permits the user to log in if verification of the hash succeeds.

4. The electronic device system according to claim 1, wherein, if the user authentication performed by the authentication processor succeeds with respect to the login request, the authentication processor transmits authentication information that has been subjected to comparison for authentication of the authentication information to the terminal device, and the terminal device stores the authentication information which has been subjected to the comparison.

5. The electronic device system according to claim 4, wherein the sender of the terminal device transmits the authentication information which has been subjected to the comparison as the login request to an electronic device different from the electronic device to which the authentication information which has been subjected to the comparison is transmitted.

6. The electronic device system according to claim 1, wherein the user setting information is changeable depending on a type of the electronic device and a user.

7. The electronic device system according to claim 3, wherein the user setting information from which the hash is created includes information that is not edited by a user.

8. The electronic device system according to claim 1, wherein the terminal device is an IC card.

9. A communication method performed by an electronic device system including an electronic device and a terminal device that communicate with each other, the communication method comprising:
storing user setting information about a setting of the electronic device in the terminal device;
transmitting the user setting information and a login request from the terminal device to the electronic device;
receiving, by the electronic device, the login request and the user setting information from the terminal device;
performing a process relating to user authentication by the electronic device using authentication information included in the login request; and
controlling the electronic device according to the user setting information if the user authentication succeeds.

10. The communication method according to claim 9, further comprising:
storing the user setting information of each of multiple users in the electronic device;
requesting the authentication information and the user setting information of a user from the electronic device by the terminal device;
acquiring the user setting information from the electronic device by the terminal device;
storing the acquired user setting information in a memory of the terminal device; and
transmitting the user setting information of the user from the electronic device to the terminal device if the user authentication performed by the electronic device succeeds.

11. The communication method according to claim 10, further comprising:
transmitting hash of the user setting information from the electronic device to the terminal device if the user authentication performed by the electronic device succeeds with respect to the login request;
storing the hash of the user setting information in the terminal device;
transmitting the hash, the login request, and the user setting information to the electronic device;
comparing hash created from the user setting information transmitted from the electronic device with the hash transmitted from the electronic device; and
permitting the user to log in if verification of the hash succeeds.

12. The communication method according to claim 9, further comprising:
transmitting authentication information that has been subjected to comparison for authentication of the authentication information from the electronic device to the terminal device if the user authentication performed by the electronic device succeeds with respect to the login request; and
storing the authentication information which has been subjected to the comparison in the terminal device.

13. The communication method according to claim 12, further comprising transmitting the authentication information which has been subjected to the comparison as the login request from the terminal device to an electronic device different from the electronic device to which the authentication information which has been subjected to the comparison is transmitted.

14. The communication method according to claim 9, further comprising changing the user setting information depending on a type of the electronic device and a user.

15. The communication method according to claim 11, further comprising creating the hash from the user setting information including information that is not edited by a user.

16. The communication method according to claim 9, wherein the terminal device is an IC card.

17. A non-transitory computer-readable recording medium storing program code that, when executed by an electronic device system including an electronic device and a terminal device that communicate with each other, causes the electronic device system to perform a communication method comprising:
storing user setting information about a setting of the electronic device in the terminal device;
transmitting the user setting information and a login request from the terminal device to the electronic device;
receiving, by the electronic device, the login request and the user setting information from the terminal device;
performing a process relating to user authentication by the electronic device using authentication information included in the login request; and
controlling the electronic device according to the user setting information if the user authentication succeeds.
